(19) United States
(12) Patent Application Publication
(10) Pub. No.: US 2010/0025341 A1
(43) Pub. Date: Feb. 4, 2010

(54) METHOD AND APPARATUS FOR FLUID CLEANING

(75) Inventors: William Lawrence Priest, West Hartford, CT (US); Gregory Allen Slawson, Saline, MI (US)

Correspondence Address: THORP REED & ARMSTRONG, LLP, ONE OXFORD CENTRE, 301 GRANT STREET, 14TH FLOOR, PITTSBURGH, PA, 15219-1425, US

(73) Assignee: Oil Purification Systems, Inc., Shelton, CT (US)

(21) Appl. No.: 12/416,491

(22) Filed: Apr. 1, 2009

Related U.S. Application Data
(60) Provisional application No. 61/129,953, filed on Aug. 1, 2008.

(51) Int. Cl. B01D 1/00; B01D 35/18

(52) U.S. Cl. 210/774; 210/180; 210/143; 210/149; 210/98; 210/137

(57) ABSTRACT

A fluid cleaning system including a fluid supply port, a fluid return port, an evaporator including an air intake vent and an air exhaust vent, a ventilation system connected to the evaporator, and a fluid line. The evaporator includes a ventilation air path through the evaporator and connected to the intake vent and the exhaust vent in the evaporator. The evaporator also includes an active airflow device located along the ventilation path. The fluid line connects the evaporator between the fluid supply port and the fluid return port.

### CROSS-REFERENCE TO RELATED APPLICATIONS

This application claims priority from U.S. provisional patent application Ser. No. 61/129,953, filed Aug. 1, 2008, which is incorporated by reference herein.

### STATEMENT REGARDING FEDERALLY SPONSORED RESEARCH AND DEVELOPMENT

Not Applicable

### FIELD OF THE INVENTION

The present invention is generally related to fluid cleaning and more specifically, but not by way of limitation, to a system and method for fluid cleaning that is configurable based on the size of the application and the type of contamination created by the application.

### BACKGROUND OF THE INVENTION

There are many methods and apparatuses that utilize fluids, such as fluids for lubricants in internal combustion engines, fluids to apply forces in hydraulic systems, fluids to regulate temperature such as in electrical transformers, and other uses of fluids. In general, it is important to keep those fluids clean and free from contaminants. However, the type and rate of contamination vary significantly for different applications.

A variety of methods and apparatuses are commonly used to remove contaminants and to keep fluids clean. Filtration is the dominant method for removing solid particulates from a fluid. Removal of liquid contaminants has also generated a significant number of technologies designed to remove them including such methods as gravity separation, centrifuge, polymer absorption, vacuum dehydration, and evaporation.

Throughout the years a number of systems have been proposed and designed utilizing both filtration and evaporation as a method for purifying a fluid by removing solid particulates and removing liquid contaminates from the fluid. In some cases these processes are carried out in a single vessel designed to perform both operations and in others it is accomplished in two chambers designed to perform the operations separately. For various reasons, either the single vessel design or the two chamber design can be argued to have an advantage over the other, yet both suffer disadvantages regardless of configuration. Furthermore, neither single vessel nor two chamber designs include the advantage of efficient air flow through the evaporative portion of the system to improve the removal of vapor generated during the cleaning of a fluid.

One problem is that the prior art typically operates with fixed ratios of filtration and evaporation with little or no means for adapting them to the particular contaminates generated by a given application. As a result, these systems are poorly adapted to applications in which conditions change over time.

Another problem is that the prior art is typically poorly adapted to variations in size, resulting in mismatched operability between the fluid cleaning system and the application from which the fluid is to be cleaned.

Another problem is that the prior art relies on the pressure differential (created during the evaporation process) between the evaporation chamber and the ambient environment to vent contaminates from the evaporation chamber. When liquid contamination is minimal, this is sufficient. However, the prior art is not well suited for more demanding applications with more fluid contaminants. In particular, there is a finite amount of evaporated contaminants that can be absorbed by the air. When this limit is reached, no additional contaminants will be absorbed. If the evaporator continues to operate in such conditions, then liquid contaminants that are evaporated will force a like amount of evaporated contaminants already in the air to condense or precipitate back into liquid form, thereby resulting in no net gain in removing liquid contaminants. Likewise, as the limit of absorption is approached, it will become increasingly difficult to remove contaminants to the air.

The prior art has failed to solve several problems inherent with fluid cleaning methods and systems, such as inefficiencies caused by poor matching of size and configuration between the fluid cleaning systems and the applications from which the fluids are being cleaned. Another short coming of the prior art is a failure to provide for efficient air flow through the evaporative portion of the system to improve the removal of vapor generated during the cleaning of a fluid.

Accordingly, there is a need for improved methods and apparatuses for fluid cleaning that includes configurable filtration and evaporation capability as well as an improved method for removing liquid contamination from the fluid. Those and other advantages of the present invention will be described in more detail herein below.

### BRIEF SUMMARY OF THE INVENTION

The present invention applies generally to fluid cleaning methods and apparatuses. The present invention will generally be described in terms of methods for fluid cleaning utilizing the process of filtration, an improved evaporation process, and a configurable apparatus that allows the system to be optimized for its intended application based on the size and operating characteristics of that application.

In one embodiment, the present invention is a system including an application, a fluid cleaning system, a supply line, and a return line. The application includes a housing, an industrial fluid within the housing, a fluid supply port and a fluid return port, wherein the fluid supply port and the fluid return port open into the housing. The fluid cleaning system includes a fluid supply port, a fluid return port, an evaporator including an air intake vent and an air exhaust vent, a ventilation system connected to the evaporator, and a fluid line connecting the evaporator between the fluid supply port and the fluid return port. The ventilation system in the fluid cleaning system includes a ventilation air path through the evaporator and connected to the intake vent and the exhaust vent in the evaporator, and an active airflow device located along the ventilation path. The supply line is connected between the supply port of the application and the supply port of the fluid cleaning system, and the return line connected between the return port of the application and the return port of the fluid cleaning system.

In another embodiment, the system further includes a fluid flow controller, a heating element in the evaporator, a sensor connected to at least one of the fluid flow controller, the heating element, and the ventilations system. The system also includes a controller connected to an output of the sensor wherein the controller includes a processor and a memory device including computer readable instructions which, when executed by the processor cause the processor to perform certain steps as described herein. For example, the processor may perform the steps of receiving data from the sensor, comparing the data from the sensor to reference data stored in the memory device, and sending a control signal to the ventilation system based on comparing the data from the sensor to the reference data.

In another embodiment, the system further includes a fluid flow controller, a heating element in the evaporator, and a sensor connected to at least one of the fluid flow controller, the heating element, and the ventilations system. The system also includes a controller connected to an output of the sensor, wherein the controller includes a processor and a memory device including computer readable instructions which, when executed by the processor, cause the processor to perform the steps of receiving data from the sensor, comparing the data from the sensor to reference data stored in the memory device, and sending a control signal to the ventilation system based on comparing the data from the sensor to the reference data.

In another embodiment of the present invention, the ventilation system includes one or more of a dehumidifier located along the ventilation path, an air filter located along the ventilation path; and a heating element located along the ventilation path.

In another embodiment of the present invention, the dehumidifier, air filter, and heating element are located in a portion of the ventilation path outside of the evaporator. In another embodiment, the dehumidifier, air filter, and heating element are located in a portion of the ventilation path inside the evaporator.

In another embodiment of the present invention, the ventilation system includes a first active air flow device located at the air intake vent and a second active airflow device located at the air exhaust vent.

In another embodiment, the present invention is a method of cleaning an industrial fluid. The method includes receiving an industrial fluid in an evaporation chamber, evaporating liquid contaminants from the industrial fluid in the evaporation chamber, and actively ventilating the evaporation chamber. Other variations of the method will also be described.

In another embodiment, the present invention is an application including a housing, an industrial fluid within the housing, and a fluid cleaning system. The fluid cleaning system may include a fluid supply port, a fluid return port, an evaporator including an air intake vent and an air exhaust vent, a ventilation system connected to the evaporator, and a fluid line connecting the evaporator between the fluid supply port and the fluid return port. The ventilation system may include a ventilation air path through the evaporator and connected to the intake vent and the exhaust vent in the evaporator, and an active airflow device located along the ventilation path.

In another embodiment, the present invention includes an apparatus for cleaning a fluid that consists of a supply manifold, filtration assemblies, and an evaporation reservoir. The present invention provides several advantages over the prior art. For example, regardless of application size, in this embodiment a single line is used to supply pressurized fluid to the system. This line going to a supply manifold allows the fluid to be uniformly distributed to one or several filter assemblies the number of which are dictated by the size and operating characteristics of the application. Filtered oil from each of these assemblies is then directed to the evaporation reservoir and one of several heater assemblies designed to add sufficient energy to the fluid flow to facilitate the state change of liquid contaminants in the fluid. The collective volume of the heater assemblies accumulates at the bottom of the reservoir and is returned to the application via a single port at the bottom of the reservoir via gravity. An advantage of this configuration is that it too can be configured to optimize the performance of the cleaning system by dictating the number of heater assemblies that are used in the process. In addition, the reservoir includes an integral air flow system designed to evacuate any vapor created during the evaporation process. For example, this can be accomplished with the use of an electric fan that either pulls or pushes air through the chamber or can be accomplished pneumatically with an air pump moving air through the chamber. This provides a significant improvement over removal of the contaminates by the pressure differential created during evaporation.

In another embodiment of the present invention an apparatus is provided for cleaning a fluid that includes a manifold, filtration assemblies, and an evaporation reservoir which includes filtration assemblies that utilize replaceable filter elements.

In another embodiment of the present invention an apparatus is provided for cleaning a fluid that includes a manifold, filtration assemblies, and an evaporation reservoir which includes filtration assemblies that utilize “spin-on” type filters.

In another embodiment, the present invention is a configurable method and apparatus for cleaning a fluid comprising a manifold, one or more filtration assemblies, and an evaporation reservoir. In the first stage, fluid enters a manifold and is distributed to one or more filtration assemblies based upon the size and solid contamination rate of the application. In the second stage of the fluid cleaning process, the fluid passes through the filter chamber and solid particulate contaminates are removed from the fluid. In the third stage the filtered fluid is transferred to one or more heater assemblies in the evaporation reservoir where liquid contaminates are evaporated and evacuated from the reservoir via filtered air flow generated by an air flow assembly. In the final stage clean “dried” fluid accumulates in the reservoir and is returned to the application.

In another embodiment of the present invention an apparatus is provided for cleaning a fluid that includes a manifold, filtration assemblies, and an evaporation reservoir which includes a reservoir that utilizes a coalescing filter on the downstream side of the air flow to collect and accumulate liquid contaminants.

In another embodiment of the present invention an apparatus is provided for cleaning a fluid that includes a manifold, filtration assemblies, and an evaporation reservoir which includes a level switch in the evaporator reservoir and a solenoid valve designed to shut-off the flow of pressurized fluid to the system should the volume of fluid exceed the capacity of the reservoir.

In another embodiment of the present invention an apparatus is provided for cleaning a fluid that includes a single filtration assembly and an evaporation reservoir.

In another embodiment of the present invention an apparatus is provided for cleaning a fluid that includes a manifold, filtration assemblies, and an evaporation reservoir which includes a transfer pump to return cleaned fluid from the reservoir back to the application.

Many variations are possible with the present invention, and teachings, variations, and advantages of the present invention will become apparent from the following detailed description of the invention.

### BRIEF DESCRIPTION OF THE FIGURES

FIG. 1 is a schematic illustrating one embodiment of the system for and method of fluid purifying as it relates to an application.

FIG. 2a is a schematic illustrating one embodiment of the fluid cleaning system according to the present invention.

FIG. 2b is a schematic illustrating one embodiment of the evaporator and ventilation system according to the present invention.

FIG. 2c is a schematic illustrating another embodiment of the fluid cleaning system according to the present invention.

FIG. 2d is a schematic illustrating another embodiment of the fluid cleaning system according to the present invention.

FIG. 3 is a schematic illustrating one embodiment of a controller according to the present invention.

FIG. 4 is a schematic illustrating another embodiment of the fluid cleaning system according to the present invention.

FIG. 5 is a schematic illustrating another embodiment of the fluid cleaning system according to the present invention.

FIG. 6 is a schematic illustrating another embodiment of the fluid cleaning system according to the present invention.

FIG. 7 is a schematic illustrating another embodiment of the fluid cleaning system according to the present invention.

FIG. 8 is a schematic illustrating another embodiment of the fluid cleaning system according to the present invention.

FIG. 9 is a schematic illustrating another embodiment of the fluid cleaning system according to the present invention.

FIGS. 10a and 10b are isometric views of one embodiment of the present invention.

FIG. 11 illustrates one embodiment of an application according to the present invention.

FIG. 12 illustrates one embodiment of an application and fluid cleaning system according to the present invention.

FIGS. 13-15 illustrate embodiments of methods according to the present invention.

### DETAILED DESCRIPTION OF THE INVENTION

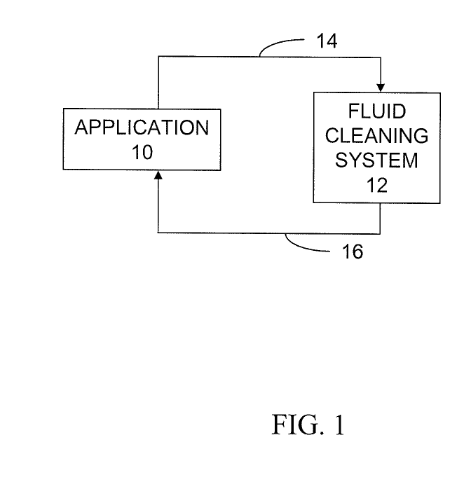

FIG. 1 is a schematic illustrating one example of the use of the present invention. In that embodiment, an application 10 is connected to a fluid cleaning system 12. Fluid from the application 10 is provided to the fluid cleaning system 12 via a supply line 14, where the fluid is cleaned as described in more detail hereinbelow. After cleaning, the fluid is returned to the application 10 via a return line 16.

The application 10 may be any mechanism or system utilizing a fluid which becomes contaminated. For example, the application 10 may be an internal combustion engine, a hydraulic system, a gearbox, or other applications. The fluid may be, for example, lubricating oil, hydraulic fluid, cooling fluid, or other fluids susceptible to contamination, such as solid particulate contamination and/or liquid contaminates. If left untreated, contaminants, both liquid and particulate, will usually reduce the usable life of the fluid and the application 10.

The fluid may be any of a wide variety of industrial fluids. Industrial fluids are used in industrial devices (i.e., applications 10) which often, but not always, have moving parts. Industrial fluids tend to become contaminated or to otherwise degrade with the use of the application 10. Furthermore, industrial fluids are typically recirculated through the industrial device, which results in the industrial fluid becoming more contaminated and more degraded with continued use of the application. As a result, industrial fluids must be either replaced or cleaned in order to maintain the proper operation of the application 10. Some examples of industrial fluids are lubricating oil, hydraulic fluid, cooling fluids, and others. Examples of industrial devices include internal combustion engines and gearboxes which have many moving parts and typically use both a lubricating oil and a cooling fluid, hydraulic devices which sometimes have a small number of moving parts (such as a single hydraulic piston) and which utilize hydraulic fluids, and electrical transformers which use cooling fluids and which may not have moving parts in the actual transformer, but which often include moving parts in the form of pumps to circulate the cooling fluid.

In operation, the fluid is transmitted via fluidic conductors (one or more supply lines 14) to the fluid cleaning system 12, where the fluid is cleaned of contaminates and then returned via fluidic conductors (one or more return lines 16) to the application 10. The flow of fluid between the application 10 and the cleaning system 12 may be controlled by the cleaning system 12, by the application 10, or by some other device. The fluid flow between the application 10 and the system 12 may be at the same fluid flow rate as the fluid passing through the application 10, or a lower fluid flow rate may be used. For example, the fluid cleaning system 12 may be series connected with the fluid flow in the application 10 so that all fluid flows through the fluid cleaning system 12 each time the fluid circulates through the application 10. In other embodiments, only a portion of the fluid is diverted to the fluid cleaning system 12, so that more than one trip through the application 10 is required before the entire volume of fluid is cleaned.

The fluid cleaning system 12 may be separate from the application 10 and connected to the application 10 via supply 14 and return 16 lines between the application 10 and system 12. In other embodiments, the system 12 and the application 10 may be integrated with each other. For example, the fluid cleaning system 12 may be part of the application 10. In such an embodiment, the supply 14 and return 16 lines may be parts within the integrated application 10 and fluid cleaning system 12 by which the fluid is carried to the portion of the integrated application 10 and system 12 that performs the cleaning of the fluid. In some embodiments, the cleaning system 12 may be integrated into the application 10 such that the industrial fluid is not diverted from its usual path within the application 10, but rather the cleaning system 12 is within a portion of the application 10 in which the fluid normally passes. For example, the application 10 may be an internal combustions engine and the system 12 may be located in the oil pan of the engine, or in some other part of the engine where the oil or other industrial fluid is normally present.

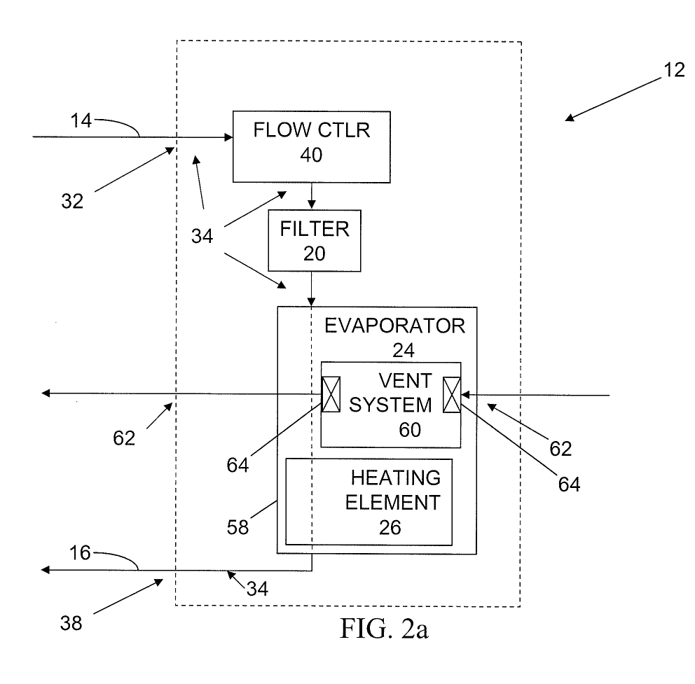

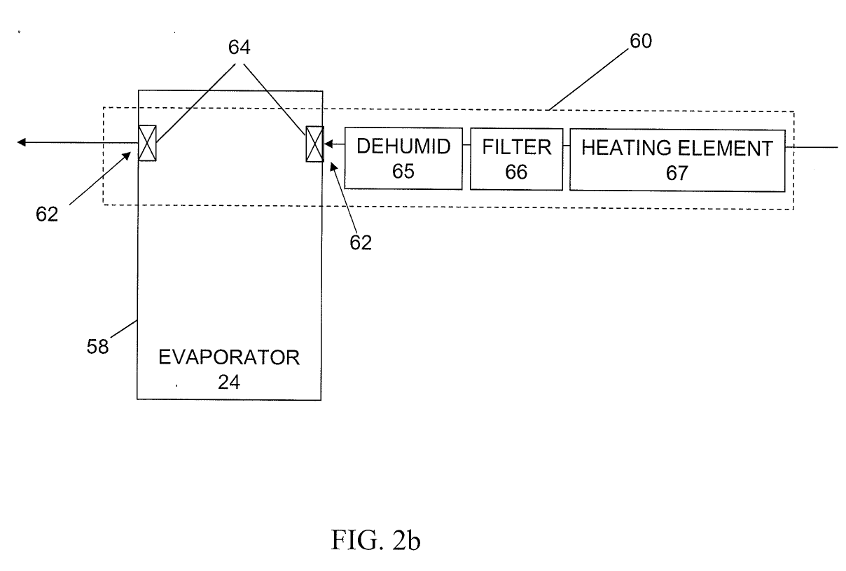

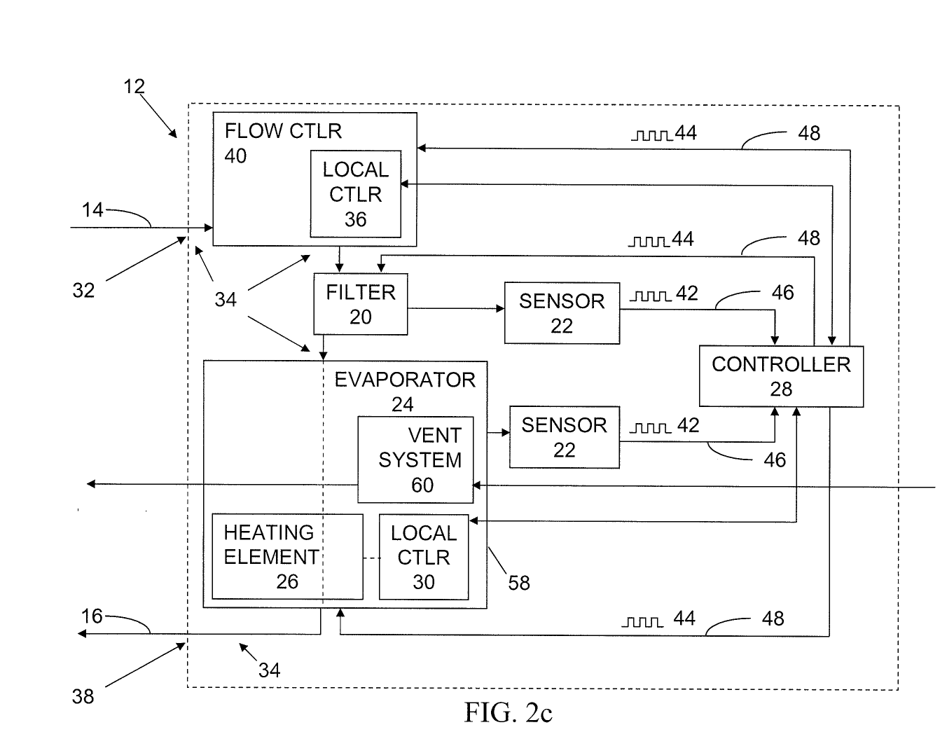

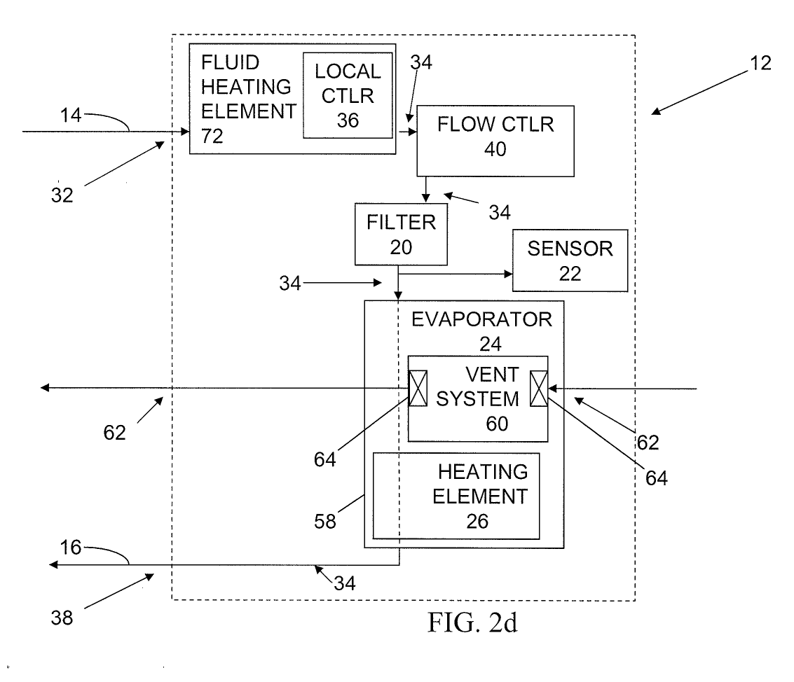

FIG. 2a is a schematic of one embodiment of the fluid cleaning system 12 according to the present invention. The fluid cleaning system 12 including a filter 20, an evaporator 24, a supply line 14, a supply port 32, a return line 16, a return port 38, and a flow controller 40. Fluid from the application 10 is carried through a supply line 14 from the application 10 and enters the system 12 through the supply port 32. The fluid is carried through one or more fluid lines 34 through the system 12 and passes through the filter 20 and the evaporator 24 where solid and liquid contaminates are removed. The fluid exits the evaporator 24 and is returned to the application 10 via the return line 16 that connects to the system 12 via the return port 38. The filter 20 and evaporator 24 may be constructed, for example, as described in U.S. Pat. No. 7,244,353, issued to Whitmore et al., and entitled “Method of and System for Fluid Purification”. Other constructions for the filter 20 and evaporator 24 are also possible with the present invention.

The filter 20 may be, for example, a conventional filter or filter medium for removing solid particulates from the fluid. The filter 20 may be an in-line filter or it may be part of a larger filtration chamber or assembly.

The evaporator 24 includes a heating element 26 and a ventilation system 60. The heating element 26 heats the fluid near the heating element 26 and thereby remove certain contaminants from the fluid. The vent system 60 actively ventilates the evaporator 24. Typically, liquid contaminants are removed from the fluid through evaporation in the evaporator 24, and the evaporated contaminants are actively vented out of the evaporator 24 via the vent system 60. The evaporator 24 may be embodied as a chamber 58, such as a cylindrical canister, in which the heating element 26 is located, through which the fluid flows, in which the liquid contaminants are removed from the fluid, and through which the ventilation system operates to remove actively remove the evaporated contaminants from the chamber 58. The shape, form, and configuration of the evaporation chamber 58, as well as the shape, form, and configuration of other parts of the evaporator 24 and other parts of the present invention, is not limited to the particular embodiments described herein. For example, the evaporation chamber 58 may be spherical, a rectangular box, an irregular shape, or other shapes and forms.

The heating element 26 can be controlled, such as by a controller (not shown) or it may be unregulated. According to some embodiments of the present invention, the heating element 26 can be controlled in response to the type of fluid and/or one or more characteristics in the system 12, such as fluid flow, fluid level, fluid pressure, fluid temperature, and other characteristics. The heating element 26 may take many forms. For example, the heating element 26 may be powered by electricity, gas, or other forms of energy. Furthermore, the element may include one or more heat generating parts, such as one or more electrically resistive portions, one or more gas burners, or other forms of heat generating parts, or combinations thereof which form the heating element. Other heating elements described herein may also be made in a variety of forms as described herein.

The ventilation system 60 actively ventilates the evaporator 24. The ventilation system 60 can be controlled, such as by a controller (not shown) or it may be unregulated. According to some embodiments of the present invention, the ventilation system 60 can be controlled in response to one or more characteristics in the system 12, such as fluid flow, fluid level, fluid pressure, fluid temperature, and other characteristics. In other embodiments, the ventilation system 60 may be unregulated and, for example, may operate continuously or on a predetermined cycle without regard to other characteristics of the system 12.

The ventilation system 60 may include one or more openings or vents 62 in the evaporator 24 and one or more active air flow devices 64, such as fans, pumps, or other devices. The vents 62 allow saturated air to leave the evaporator 24 and allow fresh air to enter the evaporator 24. The active air flow devices 64 force air to move through the evaporator 24; For example, the ventilation system 60 may force air into the evaporator 24 through an intake vent 62 so that the saturated air inside the evaporator 24 is forced out of a different exhaust vent 62 in the evaporator 24. In other embodiments, the ventilation system 60 may pull air out of the evaporator 24, thereby creating a partial vacuum within the evaporator 24 or otherwise inducing fresh air to be pulled into the evaporator 24 through an intake vent 62 in the evaporator 24. In another embodiment one air flow device 64 may force fresh air into the evaporator 24 and another air flow device 64 may pull saturated air out of the evaporator 24.

In the illustrated embodiment, the ventilation system includes two vents 62, one (intake vent) to allow air to flow into the evaporator 24 and one (exhaust vent) to allow saturated air to leave the ventilation system 60. In other embodiments the present invention may use more or fewer vents 62. For example, more than two vents 62 may be used, such as to allow for more air flow through the evaporator 24. In another example, a single vent 62 may be used if it is designed to as to allow fresh air to enter and saturated air to exit the evaporator 24. For example, a properly sized and/or shaped vent 62 can accommodate a fan 64 to force air into the evaporator 24 and also have a sufficient opening around or away from the fan 64 to allow air within the evaporator 24 to pass out through the vent 62. Other variations are also possible.

The ventilation system 60 may also include a filter 66 to filter the air being forced through the evaporator 24. The filter 66 may be a mechanical filter, an electrostatic filter, or other types of filters as are known in the art for filtering air.

The ventilation system 60 provides for increased air flow through the evaporator 24, thereby removing air saturated with evaporated contaminants from the fluid and replenishing the evaporator 24 with cleaner air. As a result, the evaporator 24 used according to the present invention will be more effective at removing liquid contaminants from the fluid.

Although the ventilation system 60 is illustrated as one path through the evaporator 24, the ventilation system 60 may include more than one ventilation path. The ventilation system 60 will be described in more detail hereinbelow.

The supply line 14 and the return line 16 connect the system 12 to the application 10. For example, the system 12 may be a separate unit connected to the application 10 via the fluid lines 14, 16. In other embodiments, the fluid lines 14, 16 may be eliminated and the system 12 may be integrated into the application 10. Although FIG. 2 illustrates one supply line 14 and one return line 16, the present invention may include more than one supply line 14 and more than one return line 16.

The supply port 32 and the return port 38 are the interfaces where the fluid enters and exits the system 12. In some embodiments the supply and return ports 32, 38 are used to connect supply and return lines 14, 16 to the system 12. In other embodiments, such as when the system 12 is integrated with the application 10, and the supply and return ports 32, 38 are the places where the fluid enters the system 12. For example, if the system 12 is integrated with the application 10, the supply port 32 may be the input to the flow controller 40 and the return port 38 may be the output of the evaporator 24. Of course, if the components of the system 12 are rearranged, such as by removing the flow controller 40, then the supply port 32 may be the input of another component, such as the input of the filter 20 or the input of some other component. Likewise, the return port 38 may be the output of a component other then the evaporator 24 in some embodiments. Although FIG. 2 illustrates one supply port 32 and one return port 38, the present invention may include more than one supply port 32 and more than one return port 38.

The fluid lines 34 in the system 12 connect certain components of the system 12 to each other and to the supply and return ports 32, 38. Although FIG. 2 illustrates the fluid line 34 connecting the flow controller 40, filter 20, and evaporator 24 in series, the present invention may include two or more parallel fluid lines 34 connecting some or all of the components in parallel, or providing parallel redundant components. For example, the system 12 may include two parallel fluid lines 34 between the supply port 32 and the return port 38, with one of the fluid lines 34 connecting the filter 20 between the supply port 32 and the return port 38, and the other fluid line 34 connecting the evaporator 24 between the supply port 32 and the return port 38. The parallel fluid lines 34 may each be connected to a separate supply port 32, or they may share a single supply port 32. For example, the two fluid lines 34 may both connect to the output of the flow controller 40. In this embodiment, fluid passes through only one of the filter 20 and evaporator 24 each time through the system 12. As a result, fluid requires more than one pass through the system 12 to pass through both the filter 20 and the evaporator 24. In another embodiment, redundant components are provided on separate, parallel fluid lines 34 so that, if a malfunction is detected, the affected components and fluid lines 34 can be disabled or bypassed, such as with additional fluid flow controllers 40, in favor of a separate and operational component or fluid line 34. Other variations are also possible.

The system 12 may operate in different modes at different times. For example, the system 12 may have an operational mode and a diagnostic mode. Other modes are also possible with the present invention.

Other parameters may also be sensed and checked against reference data, and the present invention may have more or fewer devices than are illustrated in the figures. For example, the system 12 may includes more or fewer sensors 22 and control signals 44, and they may be in locations other than those shown in the figures.

The fluid supply flow may be pressurized by a pump integral to the application 10, or by a pump external of the application 10. This pump may be the fluid flow controller 40, or it may be in addition to the fluid flow controller 40. For example, the application 10 may have a fluid flow pump that pressurizes the fluid, and the system 12 may have a fluid flow controller 40 that is in the form of a valve to control the fluid flow through the system 12. The operation of this pump and control of the fluid pressure may be controlled by the application 10 or it may be controlled independent of the application 10 (such as by the system 12).

The fluid flow controller 40 controls the flow of fluid through the system 12. The fluid flow controller 40 may be, for example, a valve that controls the flow of pressurized fluid, a pump to control the flow of fluid through the system 12, or other devices for controlling the flow of fluid through the system 12. The fluid flow controller 40 may include one fluid flow device (such as one valve or one pump to control the flow of fluid) or it may contain more than one fluid flow device. For example, the fluid flow controller 40 may include more than one valve or pump to allow for a greater range of fluid flow by operating one or more than one valve or pump. Also, the fluid flow controller 40 may include one or more primary valve or pump and one or more backup valve or pump to be used if the primary valve or pump fails a diagnostic test or is otherwise not operating properly.

Many variations are possible with the system 12, and the figures are illustrative and not limiting, and the system 12 is not limited to the particular orientation and number of elements. For example, the system 12 may include more than one fluid flow controller 40, or the system 12 may not include any fluid flow controllers 40. In the later embodiment, for example, the system 12 may rely on fluid flow controllers 40 external to the system 12, or the fluid flow rate may be unregulated in some applications. Similarly, the system 12 may include more than one filter 20, or it may not have any filters 20. In the later embodiment, for example, the evaporator 24 may provide for sufficient cleaning for some applications or a filter may be provided external to the system 12. Similarly, the present invention may include more than one evaporator 24 and/or more than one heating element 26 in each evaporator 24. In other embodiments, the system 12 may not include any evaporators 24 and the filter 20 may be sufficient for some applications or an evaporator 24 may be provided external to the system 12. Similarly, the present invention may include more or fewer sensors 22 than illustrated in the figures, and the sensors 22 may be located in positions other than that illustrated in the figures. The system 12 may also include more than one controller 28, and the controller 28 may produce more or fewer control signals 44 than are illustrated. There may also be more than one supply line 14 and supply port 32 entering the system 12, more than one return line 16 and return port 38 from the system 12, and more than one fluid line 34 carrying fluid through the system 12. Furthermore, although the filter 20 and the evaporator 24 are illustrated as being in series with each other, it is also possible for the filter to be in parallel with the evaporator 24. Also, although the filter 20 is shown upstream from the evaporator 24, it is also possible for the evaporator 24 to be upstream from the filter 20. However, some advantages may be realized by placing the filter 20 upstream from the evaporator 24 in order to remove solid contaminants from the fluid before the fluid enters the evaporator 24. Other variations and modifications are also possible. Also, although the illustrated embodiment shows local controllers 30, 36 in the evaporator 24 and fluid flow controller 40, other parts of the system 12 may also include local controllers.

FIG. 2b illustrates one embodiment of an evaporator 24 and ventilation system 60 according to the present invention. The ventilation system 60 in that embodiment includes intake and exhaust vents 62, an active airflow device 64 at each vent 62, and a dehumidifier 65, an air filter 66, and a heating element 67.

The ventilation system 60 forms a ventilation path which moves air through the evaporator 24 and through the ventilation system 60. In other words the ventilation path 60 moves air though the heating element 67, the air filter 66, and the dehumidifier 65, and then into the evaporator 24 through the intake vent and active airflow device 64 located at the intake vent 62, through the evaporator 24, and out of the evaporator 24 via the exhaust vent 62 and the active airflow device 64 at the exhaust vent. Parts of the ventilation system 60 located outside of the evaporator 24 may be connected to each other and to the evaporator 24 via air ducts or other paths for controlling the flow of air along the ventilation path 60. For example, metal, plastic, or air paths constructed of other materials may be used to control the flow of air through he ventilation system 60.

The ventilation path 60 in the illustrated embodiment span both inside the evaporator 24 and outside of the evaporator 24. In other embodiments of the ventilation system 60, the ventilation path may be contained within the evaporator 24. For example, if the heating element 67, the air filter 66, and the dehumidifier 65 of the ventilation system 60 illustrated in FIG. 2b are moved inside the evaporator 24, then the ventilation path 60 is between the intake and exhaust vents 62 of the evaporator 24. Other variations are also possible.

The dehumidifier 65 may be used to reduce the humidity of the air used to ventilate the evaporator 24. Reducing the humidity of the air can increase the amount of contaminants that can be evaporated into a given volume of air passing through the evaporator 24. Otherwise, for example, the air is already partially saturated with water vapor present in the air as it enters the evaporator 24.

The air filter 66 may be used for filtering air entering the evaporator 24. Filtering the air reduces contaminants entering the evaporator 24 and, thereby, reduces a possible source of contaminants to the fluid being treated in the evaporator 24.

The heating element 67 may be used for heating the air entering the evaporator 24 and, thereby, increasing the saturation point of the air in the evaporator 24. In some embodiments, the heating element 67 can be used in place of the heating element 26. In other words, the air passing through the heating element 67 carries energy into the evaporator 24, and that energy is transferred to the fluid in the evaporator 24, thereby causing the evaporation of contaminants from the fluid to the air. The illustrated embodiment shows an evaporator 24 without a heating element 26, although in other embodiments the heating element 26 may also be included with the heating element 67 and the heating element 67 and heating element 26 may work together. Although the present invention is generally described in terms of the heating element 26 to heat the fluid 74, the present invention may also be implemented by using the heating element 67 in place of, or in addition to, the heating element 26.

The active airflow devices 64 may be fans or other devices for actively moving air through the evaporator 24, as was discussed above. However, many variations are possible with the present invention, and the active airflow devices 64 are not limited to fans. For example, when the present invention is used with an engine as the application 10, the vacuum from the air intake system of the engine can be used as the source of air flow through the evaporator 24. In this case as in other cases, the air may be filtered to reduce contaminants entering the fluid being cleaned, and the air may also be dehumidified, heated, and otherwise processed to facilitate the desired operation.

Many variations are possible with the ventilation system 60. For example, in some embodiments the ventilation system 60 does not include all of the parts illustrated in FIG. 2b, and the parts may be arranged in different ways (for example, the dehumidifier 65 may be located upstream of the heating element 67). In some embodiments, for example, one or more of the dehumidifier 65, air filter 66, and heating element 67 may be omitted. In other embodiments, additional elements may be added to the ventilation system 60. Furthermore, in the illustrated embodiment, some portions of the ventilation system 60 are located within the evaporator 24 (e.g., the active airflow devices 64) and some portions of the ventilation system 60 are located outside of the evaporator 24 (e.g., the dehumidifier 65, air filter 66, and heating element 67). In other embodiments, all of the parts of the ventilation system 60 may be located within the evaporator 24, all of the elements of the ventilation system 60 may be located outside of the evaporator 24, or a different combination of elements may be located inside and outside of the evaporator 24. For example, the active air flow devices 64 may be located outside of the evaporator 24, such as on the other sides of the vents 62, and the dehumidifier 65, air filter 66, and heating element 67 may be located within the evaporator 24. In the case of the dehumidifier 65 being located with the evaporator 24, a path may be provided to remove the water from the dehumidifier 65 to outside of the evaporator 24.

FIG. 2c is a schematic of another embodiment of the fluid cleaning system 12 according to the present invention. That embodiment is similar to the system 12 illustrated in FIG. 2a, except that the system 12 also includes sensors 22 and a controller 28.

The ventilation system 60 in FIG. 2c is shown in a simplified form. However, it is to be understood, that the ventilation system 60 in this and in other embodiments of the present invention may contain additional details as well as the variations described herein with regard to the ventilation system 60. For example, the ventilation system 60 may include one or elements such as a dehumidifier 65, an air filter 66, and a heating element 67, as well as one or more ventilation ports 62, one or more active airflow devices 64, with all of the elements located within the evaporator 24, or all of the elements located outside of the evaporator 24, or some elements in the evaporator 24 and some elements outside of the evaporator 24. Those and other variations are discussed in more detail in other parts of this document.

The sensors 22 and the controller 28 allow for more sophisticated control of the system 12. For example, the state of the heating element 26 can be determined by the sensors 22 and that data can be used by the controller 28 to generate control signals for changing and controlling the system 12. For example, the state of the heating element 26 can be determined by the sensors 22 and that data can be used by the controller 28 to increase or decrease the temperature of the heating element 26 as needed. In another example, the state of the flow controller 40 can be sensed and control signals can be sent to the flow controller 40 to increase or decrease the flow of fluid through the system 12. In another example, one or more parameters of the system 12 or the application 10 may be monitored and that data may be used to control the ventilation system 60, such as by increasing or decreasing the air flow through the evaporator 24, increasing or decreasing the humidity and/or temperature of the air passing through the evaporator 24. This may be done, for example, by controlling the operating conditions of the active airflow devices 64 (e.g., increasing or decreasing the speed of fans). For example, if the flow of fluid through the evaporator 24 increases, or if the amount of liquid contaminants in the fluid increases, or if other data indicates increased ventilation of the evaporator 24 is needed, then the controller 28 can send appropriate signals to the ventilation system 60 to increase air flow through the evaporator 24, or to change the state of the air passing through the evaporator 24 such as by increasing the temperature and/or decreasing the humidity of that air. Similarly, if it is determined that fewer contaminants are being evaporated, then the air flow through the evaporator 24 may be reduced, the temperature may be allowed to decrease, and the humidity may be allowed to increase. Other variations are also possible and other parts of the system 12 can also be sensed and controlled.

The sensors 22 can consist of one or more sensing technologies designed to measure flow, pressure, fluid level, temperature, and other characteristics. The sensors 22 may capture and transmit data in digital form or analog form. In some embodiments, some of the sensors 22 are analog and others are digital. The data signals 42 from the sensors 22 are transmitted to the controller 28 for further processing as described in more detail herein. In some embodiments, the data signals 42 from one or more of the sensors 22 may be transmitted to one or more local controllers 30, 36. Sensors 22 may, for example, be located in positions to measure operating characteristics of the system 12, such as by monitoring characteristics at the filter 20 and the evaporator 24, as well as at other locations. The sensors 22 may be used at other locations within and outside of the system 12. For example, sensors 22 may be used to measure characteristics at the supply and return lines 14, 16 and ports 32, 38. Sensors 22 may be used to measure characteristics at the heating element 26 and the fluid flow controller 40. Sensors 22 may also be located in or near the application 10 and in other locations. In one embodiment, sensors 22 measure characteristics of the application 10 to better control the operation of the system 12, such as by measuring fluid temperature, pressure, flow rate and other parameters in the application 10. The number, type, and location of sensors 22 will vary depending on the particular embodiment and application of the present invention.

The controller 28 monitors and controls the fluid cleaning process. The controller 28 receives data signals 42 from the sensors 22 and provides control signals 44 for the proper operation of the system 12. The data signals 42 and the control signals 44 may be transmitted over data signal lines 46 and control signal lines 48, respectively. The data signal lines 46 and control signal lines 48 may be, for example, electrical conductors such as wires, optical media such as optical fiber, and wireless media such as electromagnetic waveguides or ambient air between the sensors 22 and the controller 28. In some embodiments, the controller 28 may utilize one or more separate receivers and transmitters (not shown) for receiving and transmitting the data signals 42 and control signals 44 which are then transmitted between the transmitters/receivers (not shown) and the controller 28.

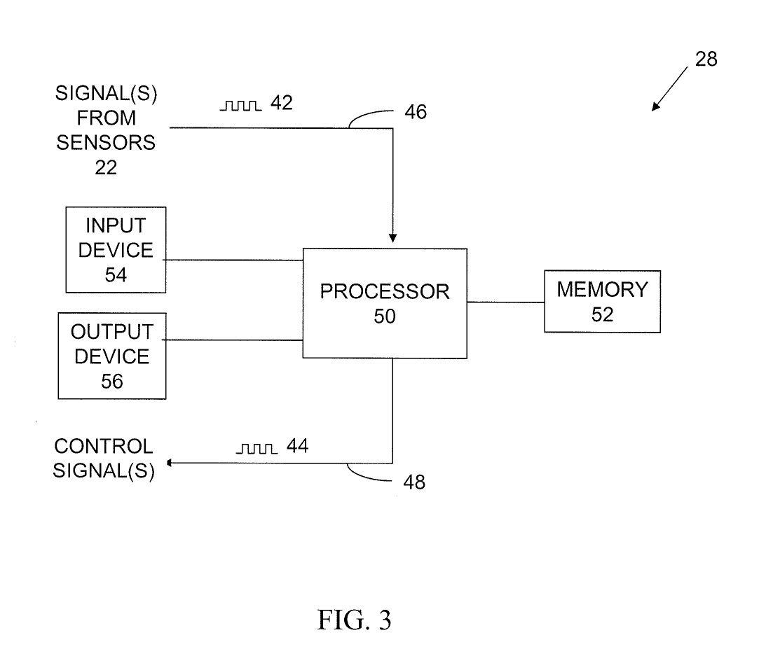

The controller 28 may also include service and diagnostic capability and may provide that functionality through either on-board displays or as an output to an external display device. Based on inputs from the sensors 22, the controller 28 will generate control signals 44 to regulate operational characteristics, such as flow, temperature, fluid level, pressure, and other characteristics, to facilitate and optimize the cleaning process. The controller 28 may, for example, operated on discrete logic, specific algorithms, or a combination of both. The controller 28 may be an integrated device or it may be made from discrete components, and the controller 28 may include or be embodied as hardware, software, firmware, and combinations thereof. The controller is described in more detail hereinbelow with reference to FIG. 3.

The controller 28 may be centrally located or it may be distributed. For example, the controller 28 may be located in a single location and receive data signals and send control signals to other parts of the system 12. In other embodiments, the controller 28 may be distributed in the form of several controllers, such as a main controller 28 and one or more local controller 30, 36 which may be collectively referred to as a controller 28.

In one embodiment of the present invention, the controller 28 monitors the operating characteristics of the system 12 and/or the application 10, and makes appropriate changes in order to provide improved operation. For example, if the controller 28, via the sensors 22 and data signals 42, detects an undesired operating condition, the controller 28 provides control signals 44 to compensate for that undesired condition, such as by changing fluid flow through the system 12, changing the temperature of the heating element 26, changing the fluid pressure, changing the level of the fluids such as by adding fluid from a reservoir (not shown) or by removing fluid from the system 12 and placing it into a reservoir (not shown), changing air flow through the evaporator 24, changing the temperature or humidity of the air in the ventilation system 60, or other changes. For example, the controller 28 can receive data signals 42 from one or more of the sensors 22, compare the data signals with “reference data”, and send control signals based on the results of comparing the data signals to the reference data. The reference data may be data indicative of one or more parameters or operating conditions of the system, such as a desired value, a desired range of values for a parameter, more than one value, more than one range of values, or combinations thereof. The reference data may relate to fluid temperature, fluid pressure, fluid flow rate, heating element temperature, rate of change of any of the parameters, as well as other data. The reference data may be stored in the controller 28 or the reference data may be stored external to the controller 28, as will be described in more detail with regard to FIG. 3.

In one embodiment, the controller 28 monitors the temperature of the fluid in the evaporator 24. If that temperature is too high, then the controller 28 sends a control signal to reduce the power to the heating element 26, and if the temperature is too low the controller 28 sends a control signal to increase the power to the heating element 26.

In another embodiment, the controller 28 monitors whether the temperature change of fluid in the evaporator 24 corresponds with expected changes in the temperature of fluid in the evaporator 24. For example, if power to the heating element 26 is increased, the fluid in the evaporator 24 will also be expected to increase. If, however, the temperature of fluid in the evaporator 24 does not show the expected temperature increase (or range of values), then the system 12 may determine that a malfunction or an unexpected condition has occurred and may take corrective action.

In another embodiment, the controller 28 monitors the fluid flow rate. If the flow rate is not within an expected range of values, the controller 28 will send a control signal to one or more fluid flow controllers 40 to adjust the fluid flow rate. For example, if a flow controller 40 in the form of a valve is opened or closed, the controller 28 may determine whether the resulting fluid flow rate corresponds with the expected fluid flow rate. If the sensed fluid flow rate is not within the expected range, the controller 28 may take further corrective action. Similarly, if the fluid flow controller 40 is in the form of a pump, the controller 28 may determine whether the resulting fluid flow rate corresponds with the expected fluid flow rate and the controller 28 may take further corrective action if the sensed fluid flow rate is not within the expected range. In other embodiments of the present invention other parameters are sensed, compared to corresponding reference data, and control signals are generated in response to the sensed data and the corresponding reference data.

If the controller 28 determines that a malfunction or an unexpected condition is occurring, the controller 28 may take action to compensate for the malfunction or unexpected condition. For example, the controller 28 may increase or decrease power to the heating element 26 more or less than would normally be required in order to compensate for a faulty heating element 26. Similarly, the controller 28 may send control signals to open or close a valve 40 or increase or decrease the speed of a fluid pump 40 more or less than would normally be required in order to compensate for a faulty fluid flow controller 40 or to compensate for a condition in a different part of the system that is affecting the fluid flow rate. Other measures may also be performed by the controller 28 to compensate for detected malfunctions or unexpected conditions. For example, the controller 28 may disable part of all of the system 12 if a malfunction is detected which would cause a significant safety risk, such as a risk of a fire, a risk of a fluid line rupture, or a risk of disabling the application 10. For example, the controller 28 may disable the heating element 26 but allow fluid to continue to flow through the system 12 so that fluid continues to receive the benefit of the filter 20 even if the evaporator 24 is not operating. In other situations, different parts of the system 12 may be disabled or the entire system 12 may be disabled.

The controller 28 can also learn from the particular application 10 with which it is operating. For example, each application 10 is slightly different, and the controller 28 can enter a mode of operation by which it monitors its operation and, based on the sensor 22 data signals 42, determines the system's 12 and/or the application's 10 baseline operational characteristics. As a result, the system 12 makes adjustments to compensate for the particular application 10 with which the system 12 is working and to bring the operation characteristics of the system 12 and/or the application 10 into a desired range. As a result, the present invention allows for quicker and easier installation of the system 12 because time previously required for calibration of the system 12 is reduced or eliminated because of the ability of the system 12 to learn and adjust.

The fluid flow controller 40 may be controlled by the controller 28. The fluid flow controller 40 may be driven by the controller 28 based on inputs from one or more sensors 22 in the system 12. For example, valves in the fluid flow controller 40 may be opened or closed to control the rate of fluid flow through the system 12 and, thereby, to control the temperature of fluid in the evaporator 24 or to control the fluid level. The fluid flow controller 40 may also be controlled to control other aspects of the system 12. Although the fluid flow controller 40 is illustrated in FIG. 2 as being inside the system 12, the fluid flow controller 40 can also be located at other locations. For example, the fluid flow controller 40 may also be located outside of the system 12, such as in the supply 14 and return lines 16 between the system 12 and the application 10, or in the application 10. Also, more than one fluid flow controller 40 may be used for additional control of the fluid flow.

The evaporator 24 may also include a local controller 30 which may communicate with the controller 28 to provide, for example, diagnostic information about the evaporator 24 as well as other data such as the temperature profile and other data. For example, the evaporator 24 may include heating element control logic and drivers which provide data to the controller 28 and which receive control signals from the controller 28. In other embodiments, the evaporator 24 may have a local controller 30 to perform other operations or no local controller 30.

The local controller 30 may communicate with the controller 28 via data signal lines 46 and control signal lines 48, or via other communication lines. The communication between the controller 28 and the local controller 30 may be bi-directional such that signals are sent from the local controller 30 to the controller 28 and from the controller 28 to the local controller 30. For example, the local controller 30 may send data to the controller 28 and the controller 28 may send control signals to the local controller 30. In other embodiments, the communication may be in only one direction. For example, the local controller 30 may only receive signals from the controller 28, and the controller 28 may receive data from sources other than the local controller 30. Similarly, the controller 28 may only receive data from the local controller 30 and may not send control signals or data to the local controller 30

The local controller 30 may operate the evaporator (e.g., the heating element 26) directly, or the local controller 30 may receive instructions from the controller 28 or from other devices. For example, the local controller 30 may perform diagnostic tests on the evaporator and determine how to operate the evaporator 24, or the local controller 30 may rely on control signals from the controller 28 for the operation of the evaporator 24. In some embodiments, the local controller 30 may receive data signals 42 directly from one or more sensors 22. In other embodiments, sensor 22 data signals 42 are provided to the controller 28, and the controller 28 determines what information is provided to the local controller 30.

The local controller 30 may be similar in design to the controller 28 and may include, for example, a processor, memory, input and output devices and other components. The memory may include computer-readable instructions which cause the process of the local controller 30 to perform the operations described herein.

The fluid flow controller 40 may also include a local controller 36 which may communicate with the controller 28 to provide, for example, diagnostic information about the fluid flow controller 40 as well as other data. For example, the fluid flow controller 40 may include control logic and drivers which control the fluid flow controller 40, such as for controlling a valve or pump, provide data to the controller 28, and receive control signals from the controller 28. In other embodiments, the fluid flow controller 40 may have a local controller 36 to perform different operations or no local controller 36.

The local controller 36 may operate the fluid flow devices (e.g., valves and pumps) directly, or the local controller 36 may receive instructions from the controller 28 or from other devices. For example, the local controller 36 may perform diagnostic tests on the fluid flow controller 40 and determine how to operate the fluid flow controller 40, or the local controller 36 may rely on control signals from the controller 28 for the operation of the fluid flow controller 40.

The local controller 36 may communicate with the controller 28 via data signal lines 46 and control signal lines 48, or via other communication lines. The communication between the controller 28 and the local controller 36 may be bi-directional such that signals are sent from the local controller 36 to the controller 28 and from the controller 28 to the local controller 36. For example, the local controller 36 may send data to the controller 28 and the controller 28 may send control signals to the local controller 36. In other embodiments, the communication may be in only one direction. For example, the local controller 36 may only receive signals from the controller 28, and the controller 28 may receive data from sources other than the local controller 36. Similarly, the controller 28 may only receive data from the local controller 36 and may not send control signals or data to the local controller 36. In some embodiments, the local controller 30 may receive data signals 42 directly from one or more sensors 22. In other embodiments, sensor 22 data signals 42 are provided to the controller 28, and the controller 28 determines what information is provided to the local controller 30.

The local controller 36 of the fluid flow controller 40 may be similar in design to the controller 28 and may include, for example, a processor, memory, input and output devices and other components. The memory may include computer-readable instructions which cause the process of the local controller 36 to perform the operations described herein.

Several examples of the present invention will now be provided. In one embodiment, the present invention includes a controller 28 which receives data from a sensor 22, compares the data from the sensor 22 to reference data stored in the memory device 52, and sends a control signal to the ventilation system 60 based on comparing the data from the sensor 22 to the reference data.

Many variations are possible with the embodiment of the invention. For example, the sensor may be connected to at least one of the heating element 26, the fluid flow controller 40, and the ventilation system 60. Also, sending a control signal to the ventilation system 60 may include sending a control signal to perform an operation when a condition is detected. The operation may be reducing airflow through the evaporator 24, reducing temperature of air entering the evaporator 24, increasing humidity of air entering the evaporator 24, or other operations. The condition that is detected may be reduced fluid flow through the evaporator 24, reduced power to the heating element 26, 67, reduced humidity in air entering the evaporator 24, increased temperature in air entering the evaporator 24, and other conditions. Other variations are also possible.

In another embodiment, the operation may be increasing airflow through the evaporator 24, increasing temperature of air entering the evaporator 24, and decreasing humidity of air entering the evaporator 24. In that embodiment, the condition may be increased fluid flow through the evaporator 24, increased power to the heating element 26, increased humidity in air entering the evaporator 24, increased temperature in air entering the evaporator 24.

In another embodiment, sending a control signal to the ventilation system 60 may include sending a control signal to reduce airflow through the evaporator 24 when fluid flow through the evaporator 24 decreases, and sending a control signal to increase airflow through the evaporator 24 when fluid flow through the evaporator 24 increases.

In another embodiment, the sensor 22 may be connected to the fluid flow controller 40, and sending a control signal to the ventilation system 60 may include sending a control signal to reduce airflow through the evaporator 24 when the fluid flow controller 40 decreases fluid flow through the evaporator 24, and sending a control signal to increase airflow through the evaporator 24 when the fluid flow controller 40 increases fluid flow through the evaporator 24.

In another embodiment, the sensor 22 is connected to the heating element 26 and sending a control signal to the ventilation system 60 may include sending a control signal to reduce airflow through the evaporator 24 when power to the heating element 26 decreases, and sending a control signal to increase airflow through the evaporator 24 when power to the heating element 26 increases.

In another embodiment, the sensor 22 is connected to the ventilation system 60; and sending a control signal to the ventilation system 60 may include sending a control signal to reduce airflow through the evaporator 24 when air entering the evaporator 24 through the ventilation system becomes wanner, and sending a control signal to increase airflow through the evaporator 24 when air entering the evaporator 24 through the ventilation system becomes colder.

In another embodiment, the sensor 22 is connected to the ventilation system 60; and sending a control signal to the ventilation system 60 may include sending a control signal to reduce airflow through the evaporator 24 when air entering the evaporator 24 through the ventilation system becomes less humid, and sending a control signal to increase airflow through the evaporator 24 when air entering the evaporator 24 through the ventilation system becomes more humid.

FIG. 2d is a schematic illustrating another embodiment of the fluid cleaning system 12 according to the present invention. In that embodiment, a fluid heating element 72 is located upstream of the evaporator 24. This fluid heating element 72 is in addition to the heating element 26 in the evaporator 24 and can be used, for example, when the fluid cleaning system 12 is used in cold environments. In cold environments, the fluid may operate at a colder temperature than is normal, or the fluid may become cold in the process of traveling to the fluid cleaning system 12. When a fluid is cold it can cause the fluid cleaning system 12 to operate less efficiently.

The fluid heating element 72 can be used to increase the temperature of the fluid so that the fluid is better suited for use in the fluid cleaning system 12. The heated fluid can aid both the solid and liquid filtering of the present invention. For example, the fluid can be heated by the fluid heating element 72 so that its viscosity or other characteristics make it more suitable for the filter 20. Similarly, the heated fluid can be more suitable for use in the evaporator 24 where liquid contaminants are evaporated from the fluid. A heated fluid can also make the fluid cleaning system 12 operate more efficiently by lowering the viscosity of the fluid, thereby making the fluid easier to move through the system 12.

The fluid heating element 72 is illustrated as being located near the supply port 32. This location may be advantageous so that that the fluid is quickly heated to a desired temperature in order to allow for easier flow of the fluid through the system 12. However, it is also possible to locate the fluid heating element 72 at other locations, such as immediately upstream of the filter 20, between the filter 20 and the evaporator 24, or in other locations. For example, if controlling the fluid temperature is not important for achieving acceptable fluid flow through the system 12, then the fluid heating element 72 may be located near the filter 20 and/or near the evaporator 24 to control fluid temperature for improved operation of the filter 20 and/or the evaporator 24 in order to better control the temperature of the fluid entering the filter 20 and evaporator 24. Other variations are also possible. For example, more than one fluid heating element 72 may be used.

The fluid heating element 72 may include or be associated with one or more sensors 22, local controller 36, or other components such as those described herein. For example, the illustrated embodiment shows a sensor 22 detecting fluid temperature near the input of the evaporator 24. This data may, for example, be provided to a local controller 36 in the fluid heating element 72 or to a different controller 28 for use in controlling the fluid heating element 72 in order to control the temperature of the fluid before it reaches the evaporator 24. The sensor 22 for the fluid heating element 72 may be located at positions other than shown herein, and more than one sensor 22 may also be used. For example, one or more sensors 22 may be used to detect the temperature of the fluid entering the system 12, to detect the temperature of the fluid leaving the fluid heating element 72, to detect the temperature of the fluid entering the filter 20, to detect the temperature of the fluid entering the evaporator 24, and at other locations. This data may also be used to control the fluid heating element 72 to ensure that the fluid is being heated to the desired temperature or temperature range for use in the fluid cleaning system 12.

The particular temperature or temperature range will depend on the fluid and the particular application. In many embodiments the ideal fluid temperature will fall between 20 C and 100 C. In other embodiments, different temperature ranges may be desired.

Many other variations are also possible. For example, although the system 12 in FIG. 2d illustrates the fluid heating element 72 containing a local controller 36, the present invention may be used without a local controller 36 in the fluid heating element 72. For example, the fluid heating element 72 may be controlled by a remote controller, such as controller 28, or the fluid heating element 72 may be manually controlled, or the fluid heating element 72 may be always on, or the other variations may be used with the fluid heating element 72. Other variations are also possible. For example, although the illustrated embodiment shows all of the fluid passing through the fluid heating element 72, it is possible for only a portion of the fluid to pass through the fluid heating element 72.

FIG. 3 illustrates one embodiment of a controller 28 according to the present invention. In that embodiment, the controller 28 includes a processor 50, memory 52, an input device 54, and an output or display device 56, such as a monitor. The processor 50 is connected to the memory 52, the input device 54, and the output device 56. The memory 52 includes computer readable instructions, such as computer hardware, software, firmware, or other forms of computer-readable instructions which, when executed by the processor 50, cause the processor 50 to perform certain functions, as described herein.

The processor 50 receives input from the input device 54, provides signals to control the output device 56, receives input signals 42 from the sensors 22, and provides control signals 44 to other parts of the system 12 or to parts outside of the system 12. For example, the processor 50 may change operating characteristics of the system 12 by sending control signals 44 to the evaporator 24 or to other parts of the system 12. In one example, the processor 50 may change the temperature of evaporator 24 by increasing or decreasing power to the heating element 26. In another example, the processor 50 may control the fluid flow controllers 40 or otherwise change the flow rate of fluid through the system 12. The processor 50 may also perform other functions and send other control signals 44, as described herein.

The memory 52 can be any form of computer-readable memory, and may store information in magnetic form, optical form, or other forms. The memory includes computer readable instructions which, when executed by the processor 50, cause the processor 50 to perform certain functions, as described herein. The memory 52 may also include the reference data. The memory 52 may be separate from the processor 50, or the memory 52 may be integrated with the processor 50. The memory 52 may also include more than one memory device, which may be integrated with the processor 50, separate from the processor 50, or both. The memory 52 may include, for example, both volatile memory and non-volatile memory for use as needed.

The input device 54 may be a keyboard, a touchscreen, a computer mouse, or other forms of inputting information from a user. The input device may, for example, allow an operator to change operational characteristics of the system 12, to provide input for later use (such as notations of conditions when a particular event occurs), and other input. The input device may also be used for maintenance, trouble shooting, and other diagnostic functions, as well as to provide updates and changes to the systems.

The output device 56 may be a video display or other forms of outputting information to a user. For example, the output device 56 may display information and warning about the system 12, such as the current operational state of the system, a notice when maintenance is required, a warning when an unsafe or otherwise undesirable operating condition exists, and providing information for maintenance, trouble shooting, and other diagnostic functions.

The controller 28 is not limited to the illustrated embodiment. For example, the controller 28 may include more than one processor 28, more than one memory device 52, more than one input device 54, more than one output device, no input device 54, and no output device 54. Also, the controller 28 may be connected to more than one data signal line 46, may be connected to more than one control signal line 48, may receive more than one signal 42 from the sensors 22, and may provide more than one control signals 44.

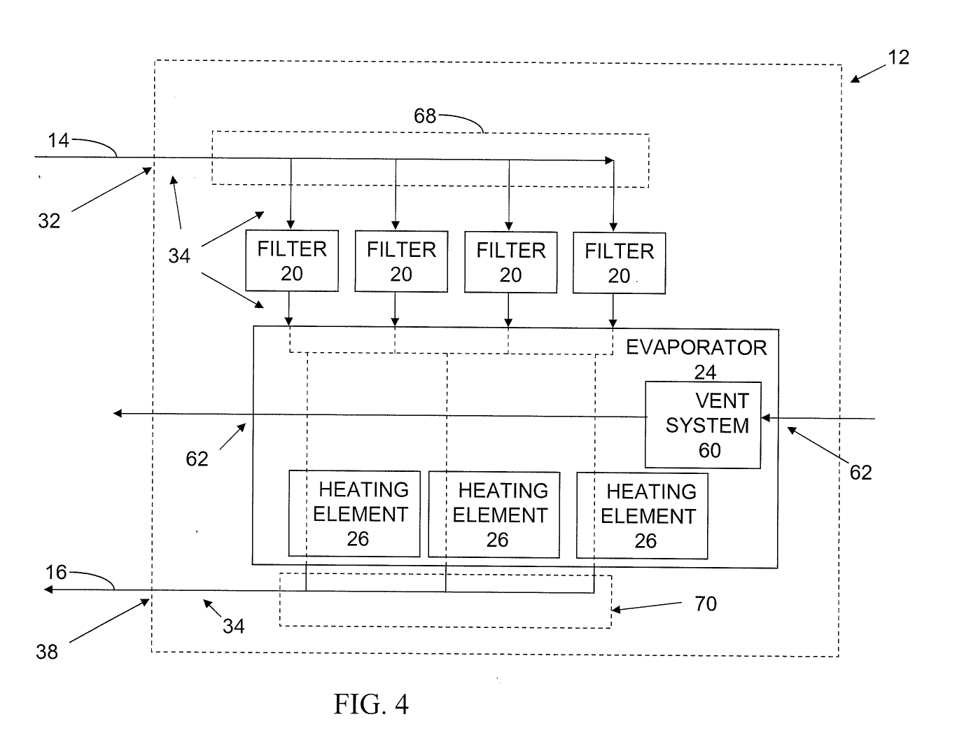

FIG. 4 is a block diagram illustrating another embodiment of the fluid cleaning system according to the present invention. In that embodiment, the system 12 includes an input fluid distributor 68, such as a manifold, and an output fluid collector 70, such as a manifold, and several parallel filters 20 which share a common evaporator 24 with several heating elements 26. Other variations of the present invention are also possible, such as using more or fewer than four filters 20, using more than one evaporator 24, using more or fewer heating elements, and other variations.

Fluid from the application 10 enters the fluid cleaning system 12 through a supply line 14 and is distributed to the filters 20, the number of which is dependent on the solid particulate contamination rate of the given application 10. The fluid proceeds from the filters 20 to the evaporator 24 where it is distributed to one or more heating elements 26, the number of which is dependent on the liquid contamination rate of the given application 10 and the interval at which it is expected to be serviced. As the fluid passes through the heating elements 26, sufficient energy is applied to the fluid to cause the state of the liquid contaminates to change from liquid to vapor. In their vapor form, liquid contaminants are absorbed by a air flow 22 passing through the evaporator 24 and carried out through an exhaust port. The dried fluid flow proceeds past the heating elements 26 and out of the evaporator 24. In some embodiments, the fluid accumulates in a reservoir 74 in the bottom of the evaporator 24. It is then returned to the application 10 via a return line 16.

The fluid cleaning system 12 is illustrated and taking four fluid lines from the filters 20 and producing three fluid lines going into the heating elements 26. This feature is not required and in other embodiments the fluid passes directly from the filters 20 the heating elements 26 without being combined with fluid passing through the other filters. In other embodiments the fluid flow may be modified in other ways, such as having more fluid lines going to the heating elements 26 than there are fluid lines coming from the filters 20. Other variations are also possible with the fluid lines in the system 12. Similarly, the system 12 is illustrated as having an input manifold 68. In other embodiments that manifold 68 may be eliminated such as, for example, with the use of one supply line 14 for each filter 20 and no input manifold 68. Similarly, the output manifold 70 may also be eliminated in some embodiments through the use of multiple return lines 16.

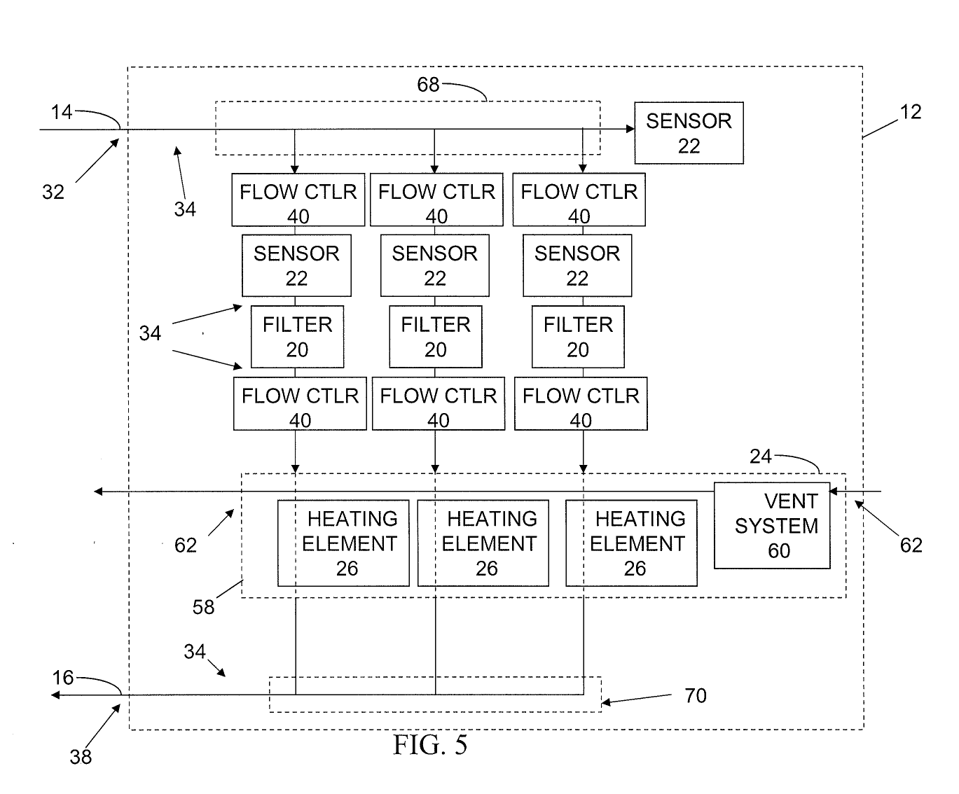

FIG. 5 is a schematic illustrating another embodiment of the fluid cleaning system 12 according to the present invention. Pressurized fluid from the application 10 is directed to the manifold 68 through a supply line 14. The pressurized flow is detected by a sensor 22 connected to the fluid in the manifold 68. That sensor 22 may be, for example, a pressure switch which, when the fluid provides sufficient force, changes its state to indicate the presence of a predetermined fluid pressure in the manifold 68. The pressure switch may, for example, be in the manifold 68 or it may be a discrete component in the manifold, or it may be located outside of the manifold. A signal from the pressure switch sensor 22 triggers the ventilation system 60 to power on generating air flow through the evaporator 24. Pressurized fluid is also distributed from the manifold 68 to one or more filter 20 supply lines 12. The illustrated embodiment shows three fluid lines leaving the manifold, although the present invention may be practiced with more or fewer than three lines.

Flow to the filters 20 is controlled by the flow controllers 40. In the illustrated embodiment, the first flow controller 40 in each fluid line after the manifold may be, for example, a shut-off valve, to allow for the selective use of each filter 20. When the shut-off valve 40 is open, flow is directed to the filter 20 through fluidic conductors where solid particulates are removed from the flow of fluid as it passes through the filters 20. After exiting the filters 20, the pressurized fluid passes by another sensor 22 which may be, for example, a pressure switch. If the fluid has sufficient pressure, it causes the pressure switch to change state closing a power circuit to one or more heating elements 26 in the evaporator 24. The fluid then enters flow controller 40 to limit the flow into the heating elements 26.

As the fluid flow passes through the heating elements 26, sufficient energy is added to the fluid to facilitate the state change of liquid contaminants in the fluid. The contaminates in vapor form, rise into the filtered air stream 22 passing through the evaporator 24 and are carried out of the evaporator 24 through the exhaust vent 62 opposite the input vent 62 of the vent system 60. The “dried” fluid exits the heating element 26 and accumulates at the bottom of the evaporator 24. The collective volume of fluid from the heating elements 26 then exits a return port 38 and is directed back to the application 10 via a return line 16.

The flow controller 40 may be a flow control valve if the pressure and flow of the application is not known prior to installation and requires adjustment at the time of installation. It may also be a fixed orifice designed to limit the flow through the system if the flow and pressure are known.

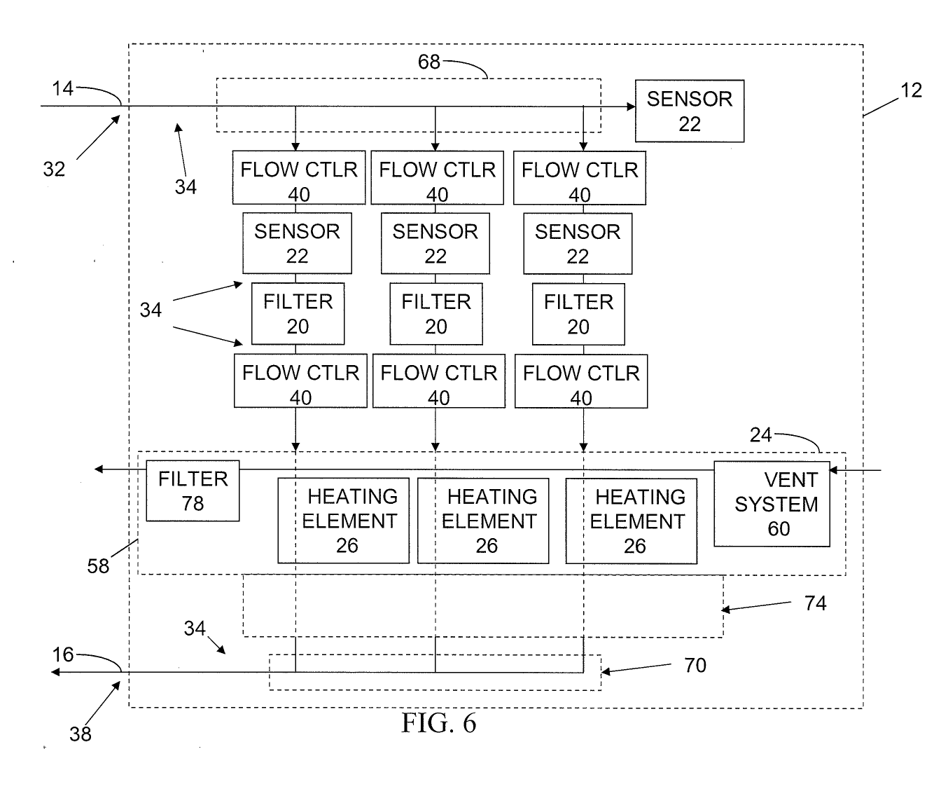

FIG. 6 is a schematic illustrating one embodiment of the fluid cleaning system 12 according to the present invention. This embodiment is similar to that shown in FIG. 5 with the addition of a coalescing filter 78 downstream of the exhaust port 8 of the evaporator 24. In cases where excessive vapor exiting the evaporation reservoir may be detrimental to adjoining equipment or facilities, a coalescing filter 17 is added to remove any vapor in the air stream. Accumulated liquid from the filter can then be periodically removed and disposed of during regular maintenance of the fluid cleaning system 12.

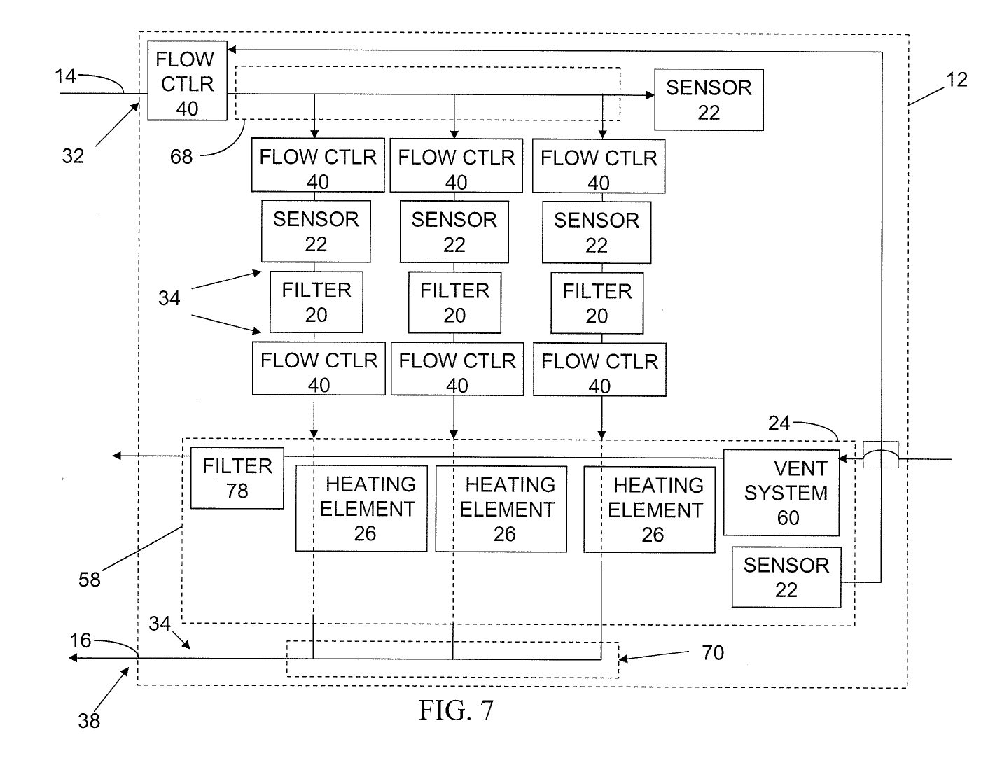

FIG. 7 is a schematic illustrating one embodiment of the fluid cleaning system 12 according to the present invention. This embodiment is similar to that shown in FIG. 6 with the addition of an additional flow controller 40 in the supply line 14 and a sensor 22 in the evaporator 24. This flow controller 40 in the supply line may be, for example, a solenoid valve upstream of the manifold 3 and the sensor 22 may be, for example, a liquid level switch in the evaporator 24. For applications that are subject to large fluctuations in pressure and or flow, a flow controller 40 may not be capable of maintaining a properly regulated flow of fluid into the fluid cleaning system 12. For applications that may potentially generate supply flows in excess of the return, a sensor 22 in the evaporator 24, such as a liquid level switch may be used to determine the fluid level in the evaporator 24. If the fluid level in the evaporator 24 exceeds a specified limit it causes the sensor 22 in the evaporator 24 to trigger the operation of the flow controller 40 in the supply line 14 to stop or reduce the flow of fluid to the manifold 68. Once the fluid level in the evaporator 24 drops below a specified level the sensor 22 in the evaporator 24 will change state back to its original state reversing the input to the flow controller 40 in the supply line 14, thereby allowing the flow to the manifold 68 to resume.

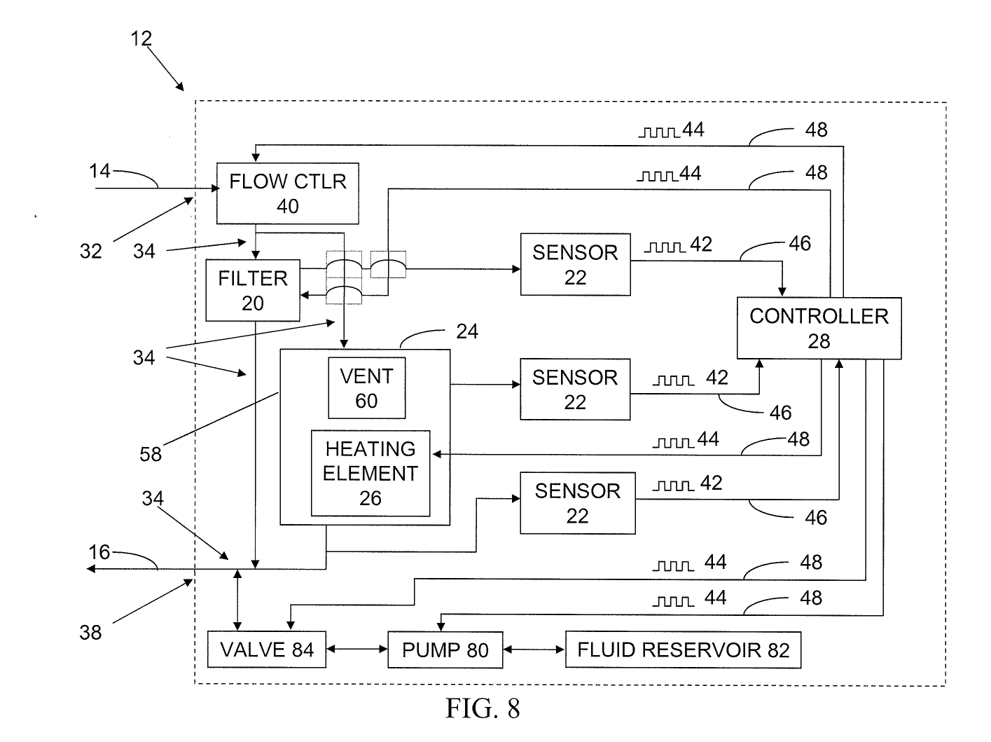

FIG. 8 illustrates another embodiment of the system 12. In that embodiment, there are two parallel fluid lines 34, with the filter 40 in one of the fluid lines 34 and the evaporator 24 in the other fluid line 34.

FIG. 8 also illustrates a pump 80 and a fluid reservoir 82 connected to the fluid line 34 via a valve 84. Control signal lines 48 connected between the controller 28 and both the valve 84 and the pump 80 allow the controller 50 to open and close the valve 84 and to control the pump 80 so as to add and remove fluid from the system 12. In this way, the fluid level may be controlled. For example, the fluid level may be reduced by moving fluid from the fluid lines 34 to the reservoir 82. Conversely, the fluid level may be increased by moving fluid from the reservoir 82 to the fluid lines 34. In other embodiments the pump 80 and reservoir 82 may be connected at a different location along the fluid line 34 or they may be connected at a location other than the fluid line 34. For example, the pump 80 and reservoir 82 may be connected via the valve 84 at the evaporator 24, the filter 20, the supply line 14, the return line 16, or at other locations in the system 12. The fluid level may be controlled in response to data from one or more sensors 22, such as a sensor 22 for detecting the fluid level in the evaporator 24 so as to control the fluid level and prevent fluid from overflowing the evaporator 24. Sensors in other locations and the control of the fluid level for other purposes is also possible with the present invention.

One or more sensors 22 may also be used to provide data regarding the fluid level to the controller 28, and the controller may use the data from the sensor 22 to determine whether to add fluid or to remove fluid from the fluid lines 34. In the illustrated embodiment, one sensor 22 is connected to the fluid line 34 after the output of the evaporator 24, although the sensor 22 may also be connect to other parts of the system 12, such as before the evaporator 24, inside the evaporator 24, before, after, or inside the filter 20, or at other places in the system 12. In other embodiments, more than one sensor 22 may be used. The use of the valve 84, pump 80, and reservoir 82 is not limited to the illustrated embodiment, and the valve 84, pump, 80 and reservoir 82 may also be used in other embodiments of the system 12, such as in embodiments in which the filter 20 and evaporator 24 are in series, in embodiments where redundant filters 20 and evaporators 24 are used, and in other embodiments.

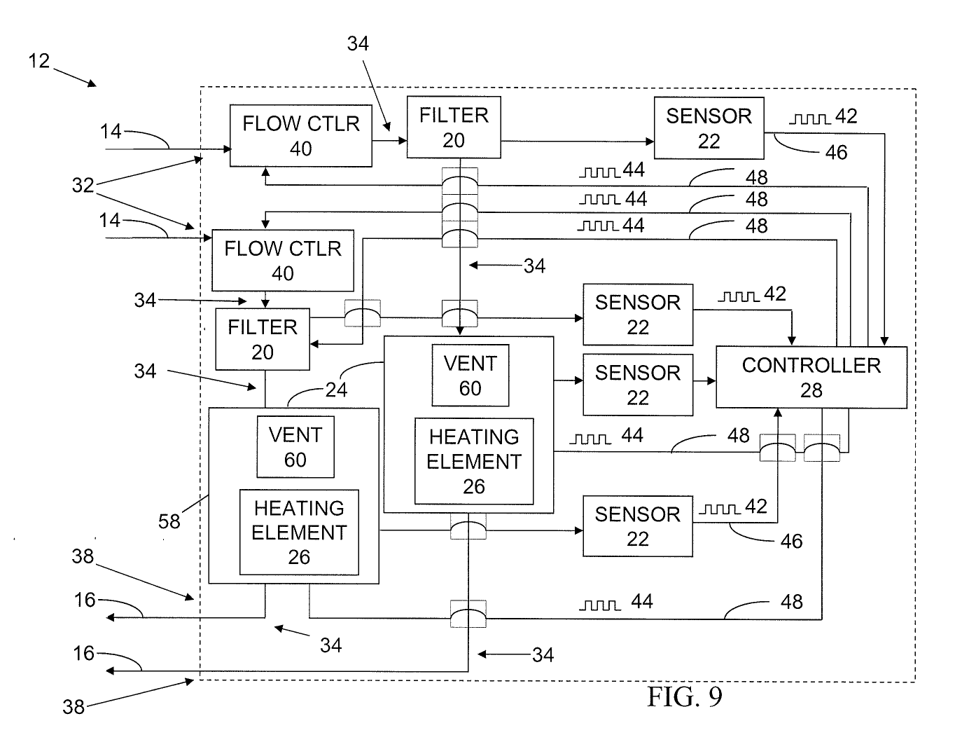

FIG. 9 illustrates another embodiment of the system 12. In that embodiment, there are two parallel fluid lines 34, with a filter 20 and an evaporator 24 in each of the parallel fluid lines. There are also two supply lines 14, two supply ports 32, two return lines 16 and two return ports 38. There are also two fluid flow controllers 40, one connected to each of the supply ports 32. The two fluid flow controllers 40 allow for separate control of fluid through the two sets of filters 20 and evaporators 24. As a result, fluid may flow through only one set of filter 20 and evaporator 24 until a malfunction is detected, at which point fluid flow to the malfunctioning filter 20 and evaporator 24 may be stopped and the fluid routed through the other filter 20 and the other evaporator 24. In other embodiments one supply line 14, one supply port 32, one return line 16, and one return port 38 may be shared and the fluid may still be controlled as described above with the use of two fluid flow controllers 40. In other embodiments, fluid may be allowed to flow through all filters 20 and evaporators 24 at the same time in order to allow for a more fluid to be cleaned. Other variations are also possible.

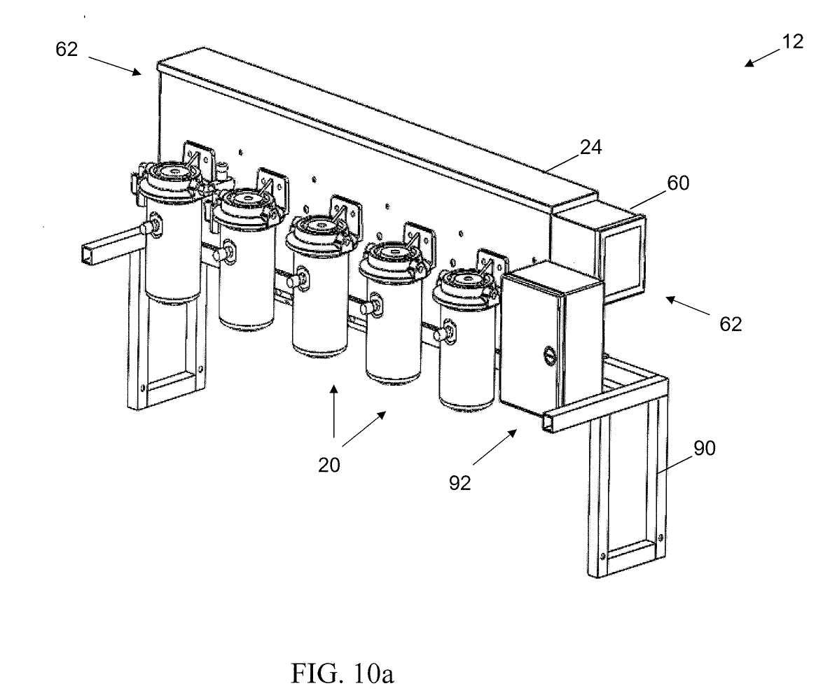

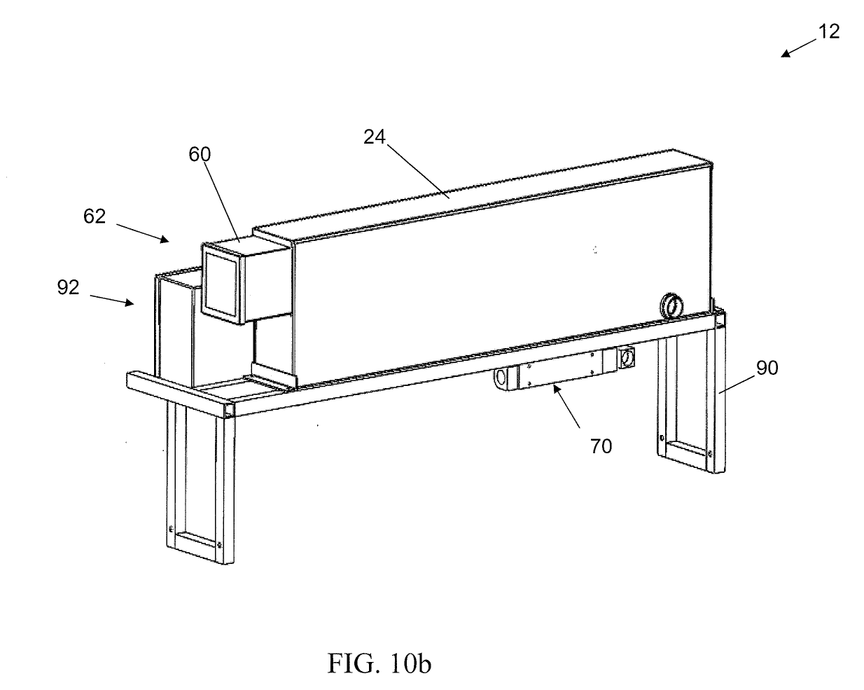

FIGS. 10a and 10b illustrates front and back isometric views of one embodiment of the fluid cleaning system 12 according to the present invention. In this embodiment an evaporator 24 is mounted on a support frame 90 that allows mounting to an application 10 ventilation system 60 is attached to one end of the evaporator 24 and an exhaust port 62 is mounted on the opposite end. One or more filters 20 are also mounted to and supported by the evaporator 24. In addition to supporting the evaporator 24, the frame is also used to mount and support the input and output manifolds 70, an electrical enclosure 92 used to consolidate and distribute electrical connections to the various components of the fluid cleaning system 12, and other parts of the fluid cleaning system 12.

The filter 20 may be a conventional filter or filter medium for removing solid particulates from the fluid. The filter 20 may utilize a spin on type filter medium or it may utilize a replaceable element.

In another embodiment, the heating element 26 in the evaporator 24 is eliminated and the ventilation system 60 is modified to include a heating element 67. In this embodiment evaporation is achieved as a result of the exposure of the fluid from the evaporator housing to a heated stream of air flowing through the reservoir.

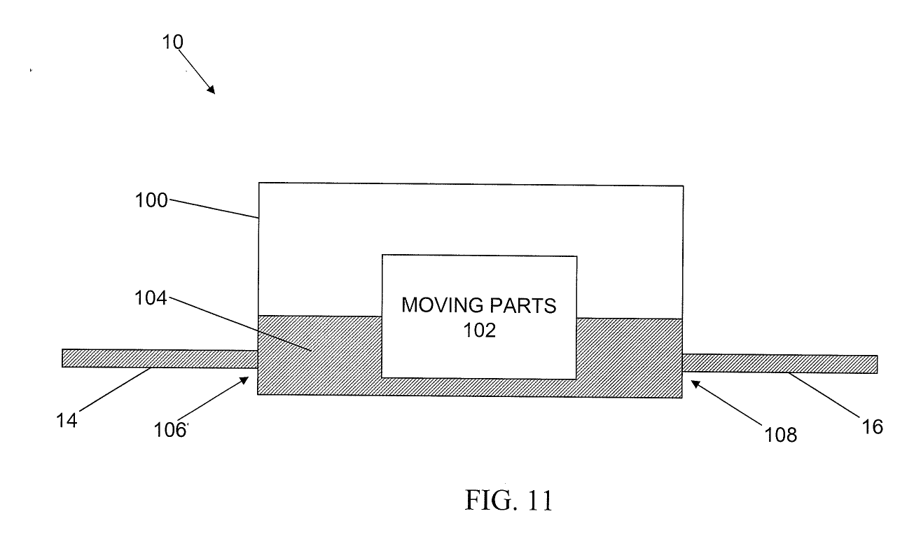

FIG. 11 illustrates one embodiment of the application 10 according to the present invention. The application 10 may be an internal combustion engine, a gearbox, a hydraulic device, or other devices. The application 10 includes a housing 100 and may include one or more moving parts 102. The housing also includes the fluid 104 within the housing 100, a fluid supply port 106 in the housing 100, and a fluid return port 108 in the housing 100. Although the application 10 illustrated in this figure includes moving parts 102 and the industrial fluid 104 may be, for example, a lubricant for the moving parts, according to other embodiments of the present invention, the application 10 may not have moving parts 102 and the industrial fluid 104 may be, for example, a coolant.

The housing 100 may completely enclose the application 10, or the housing may enclose only a portion of the application 10. For example, the housing may be the crank case or an oil tank on an internal combustion engine, or the housing 100 may be a fluid reservoir in a hydraulic device. The housing 100 may also take other forms.

The moving parts 102 within the housing 100 may be, for example, pistons, valves, and a crankshaft in an internal combustion engine, a piston that moves within a cylinder in a hydraulic device, gears and shafts in a gearbox, a fluid circulation pump in an electrical transformer, as well as other or different moving parts.

The fluid 104 may be an industrial fluid as described above. The fluid is typically contaminated by the operation of the application and, if left untreated, can cause reduced performance of the application 10 and, in some cases, failure of the application 10.

The supply port 106 is an opening through which the fluid leaves the application 10 and is carried via one or more supply lines 14 to the fluid cleaning system 12. Although the illustrated embodiment shows only one supply port 106, the present invention may also be used with two or more supply ports 106.

The return port 108 is an opening through which the fluid returning from the fluid cleaning system 12 returns to the application 10. Although the illustrated embodiment shows only one return port 108, the present invention may also be used with two or more return ports 108.

The fluid cleaning system 12 may operate in the same mode at all times, such as by monitoring one or more parameters of the system 12 and making adjustments to the system 12 to maintain a desired operational state. In other embodiments, however, the system 12 may operate in different modes at different times. For example, the system 12 may be in an operational mode at some times and the system 12 may operate in a diagnostics mode at other times. In other embodiments, the system 12 may have more than two modes of operation, or the system 12 may operate in modes other than those described herein.

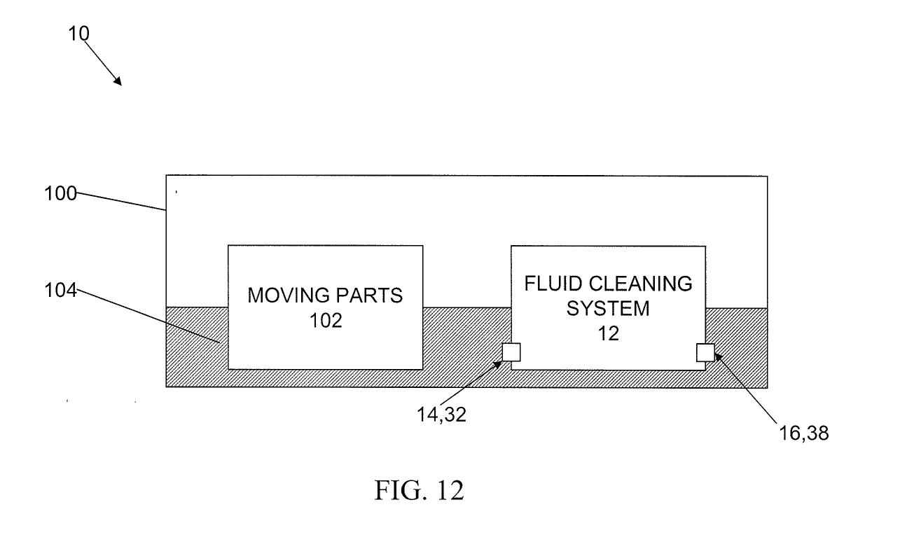

FIG. 12 illustrates an integrated application 10 and system 12 according to one embodiment of the present invention. In this embodiment, the system 12 is part of the application 10. For example, the application 10 may be an internal combustion engine and the fluid cleaning system 12 may be located within the oil pan of the internal combustion engine, or within a passage or line that carries the oil or other industrial fluid, or within some other part of the engine by which the industrial fluid is provided to the system 12.

Although the system 12 is shown within the fluid 104, in other embodiments the system 12 may be entirely out of the fluid 104, such as in another part of the application 10 or located above the level of the fluid 104, and the fluid 104 may be moved to and from the system 12 such as with supply 14 and return 16 lines as described above. Also, as discussed above, the application 10 may or may not include moving parts 102.

The illustrated embodiment shows the system 12 including supply 32 and return 38 ports and supply 14 and return 16 lines so that the fluid 104 can enter and leave the system 12. In other embodiments, the system 12 may have no housing or walls to separate it from the application 10. In such an embodiment, there may be no supply and return ports 32, 38 and supply and return lines 14, 16. In other embodiments, the supply and return ports 32, 38 and the supply and return lines 14, 16 may be openings, passages or other fluid passageways between one or more parts of the system 12 and other parts of the application 10.

In one embodiment, the present invention is an apparatus including an application 10 including a housing 100, an industrial fluid 104 within the housing 100, a fluid flow controller 40, and a fluid cleaning system 12. The fluid cleaning system 12 may have many variations as described above. For example, the system 12 may include an evaporator 24, a sensor 22 connected to at least one of the fluid flow controller 40 and the evaporator 24, and a controller 28 connected to an output of the sensor 22. The controller 28 has many variations as described above. For example, the controller 28 may include a processor 50 and a memory device 52 including computer readable instructions which, when executed by the processor cause the processor 50 to perform steps described herein. For example, the steps may be receiving data from the sensor 22, comparing the data from the sensor 22 to reference data stored in the memory device 52, and sending a control signal to at least one of the evaporator 24 and the fluid flow controller 40 based on comparing the data from the sensor 22 to the reference data.

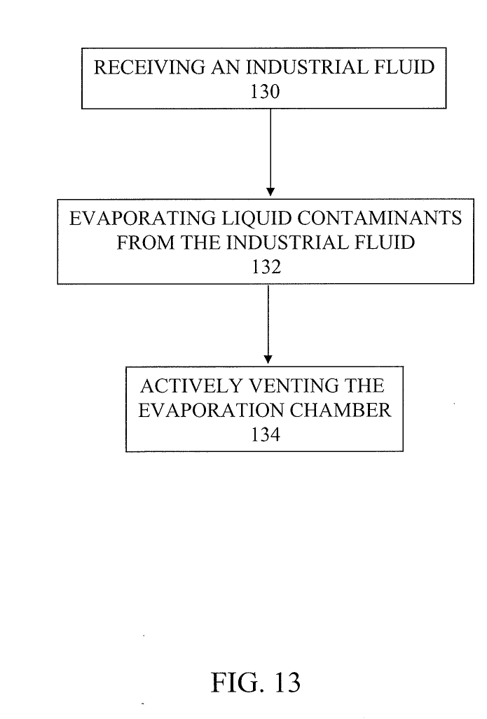

FIG. 13 illustrates an embodiment of a method according to the present invention. The method may be implemented by one or more the apparatuses described herein, or it may be implemented by different apparatuses.

Step 130 includes receiving an industrial fluid in an evaporation chamber 58. The industrial fluid may be provided to the chamber 58 as described above.

Step 132 includes evaporating liquid contaminants from the industrial fluid in the evaporation chamber. The liquid contaminants may be evaporated by heating the industrial fluid such as, for example, through the use of a heating element 26 in the evaporation chamber 24, with heated air flowing through the evaporation chamber 58 via the ventilation system 60, or in other ways.

Step 134 includes actively ventilating the evaporation chamber 58. As described above, this may be accomplished with fans 64 or other devices for actively ventilating the evaporation chamber 58.

Many variations are possible with the method described in FIG. 13.

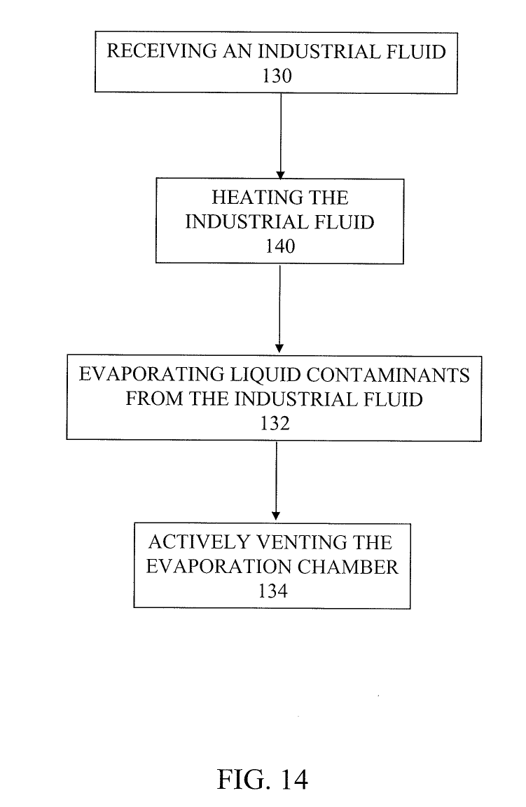

FIG. 14 illustrates another embodiment of the method according to the present invention. The method of FIG. 14 is similar to the method of FIG. 13 except that there is an additional step 140, which includes heating the industrial fluid prior to the evaporation step 132. For example, the heating step 140 may include heating the industrial fluid before the industrial fluid is received in the evaporation chamber 58. The heating step 140 is described above with regard to the fluid heating element 72 in FIG. 2d. In particular, this heating 140 is separate from the heating that is part of the evaporation step 140. For example, the fluid may be heated after entering the fluid cleaning system 12 and before the fluid enters the evaporator 24, and this heating step 140 may be performed when the industrial fluid is colder than desired for the operation of the present invention. Other variations of the method are also possible.

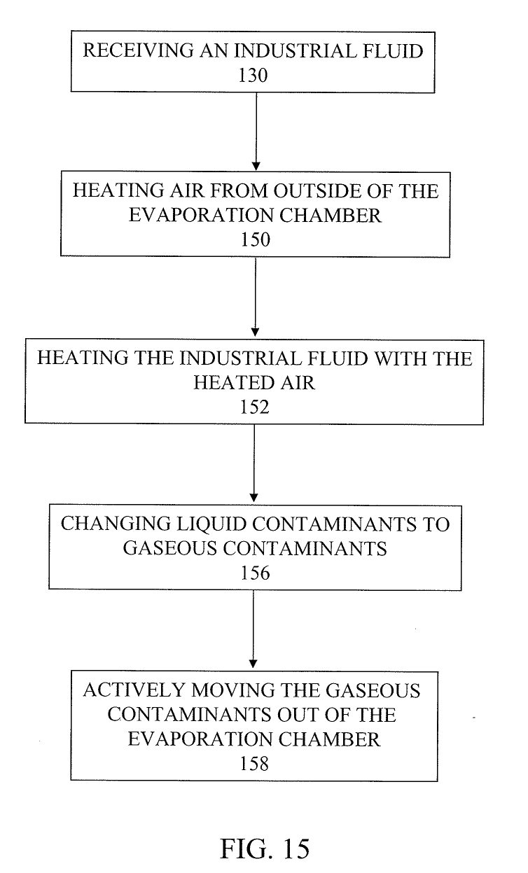

FIG. 15 illustrates another embodiment of a method according to the present invention. The method may be implemented by one or more the apparatuses described herein, or it may be implemented by different apparatuses.

Step 130, as described above, includes receiving an industrial fluid 74 in an evaporation chamber 58.

Step 150 includes heating air from outside of the evaporation chamber 58 to form heated air. In particular, in this embodiment of the method, air in the ventilation system 60 is heated and that heated air is used to heat the industrial fluid 74, as illustrated in Step 152.

Step 152 includes heating the industrial fluid 74 with the heated air in the evaporation chamber.

Step 154 includes changing liquid contaminants in the industrial fluid 74 to gaseous contaminants in the evaporation chamber 58. As described above, heating the industrial fluid 74 can cause liquid contaminants in the industrial fluid 74 to evaporate.

Step 156 includes actively moving the gaseous contaminants out of the evaporation chamber 58. As described above, active ventilation of the evaporation chamber 58 can be accomplished, for example, with one or more fans 64 or other devices. For example, a fan or some other active airflow device 64 at an input vent 62 of the evaporation chamber 58 may be used to actively move air into the chamber 58 and the action of that same fan may also actively move air (containing gaseous contaminants that have been evaporated out of the industrial fluid 74) out of the evaporation chamber 58. Similarly, a fan or some other active airflow device 64 at an output vent 62 of the evaporation chamber 58 can actively move air out of the chamber 58 and the action of that same fan may also actively move air into the evaporation chamber 58 via a input vent 62. Move than one active airflow device 64 may also be used, such as one or more at an input vent 62 and one or more at an output vent 62.

Many variations are also possible. For example, heating air from outside of the evaporation chamber may include heating the air while it is still outside of the evaporation chamber 58. In such an embodiment, the heated air would subsequently be actively moved into the evaporation chamber 58 and used to for heating the industrial fluid 74.

Alternatively, the air can be heated within the evaporation chamber 58. For example, the method could include actively moving the air into the evaporation chamber before heating the air. After the air was in the evaporation chamber 58, the method would include heating the air inside of the evaporation chamber 58.

Many other variations are also possible. For example, the method can include filtering the air and reducing the humidity of the air flowing through the ventilation system 60. Filtering and dehumidifying the air may be performed before heating the industrial fluid 74 with the heated air, as described above. Filtering and dehumidifying the air may both be performed, or only one or none of these actions may be performed with the method. Furthermore, filtering and dehumidifying the air may be performed independent of whether the air in the ventilation system 60 is heated.

Many other modification and variations are possible with the present invention. For example, the system 12 may include more than one filter 20, evaporator 24, heating element 26, controller 28, supply line and port 14, 32, return line and port 16, 38, processor 50, memory 52, input device 54, output device 56 and other elements. In addition, devices not shown may also be included in the system 12, and some devices shown in the figures (such as the input device 54 and the output device 56) may be combined or integrated together into a single device, or omitted altogether. Also, the relative locations of devices and components may be changed. For example, although it is preferable for the filter 20 to be located upstream from the evaporator 24, it is possible to realize at least some benefits of the present invention by locating the evaporator 24 upstream from the filter 20.

Modes of operation may be performed by the controller 28, or the modes may be operated, in whole or in part, by other processors or controllers, such as the local controllers 30, 36. For example, the local controllers 30, 36 may perform diagnostics on their portion of the system 12 and send results of the diagnostics to the controller 28 for further processing. Alternatively, the local controllers 30, 36 may perform diagnostic tests, make adjustments based on the results of the diagnostic tests, and execute the adjustments either with or without receiving control signals from the controller 28. Other variations are also possible.

Finally, the fluid cleaning system 12 may be built in a mobile version that may be moved from application 10 to application 10. In cases where it may not be feasible to attach the cleaning system 12 to the application 10 or when its use is infrequent it may prove to be more cost effective to utilize a mobile version of the system 12. In this embodiment, any of the previously described systems 12 can be mounted on a “cart” that can be easily moved from one application 10 to another. In addition to the cart, these systems would include a pump that would circulate fluid through the fluid cleaning system 12, a pump to evacuate the evaporation reservoir 24, a supply line 14, and a return line 16. Vacuum would be used to draw the fluid from the reservoir of the application 10 through the supply line 14 on the upstream side of the pump and on the downstream side, pressure would force a portion of the fluid through the cleaning system 12 and the rest back to the application 10 through the return line 16. As a result of the fluid becoming “depressurized” during the evaporation process a second pump would be used to force the contents of the evaporation reservoir 24 into the return flow of fluid back to the application 10 through the return line 16. This process would continue for a period sufficient to obtain the cleanliness levels required for the application 10.

Furthermore, although the present invention has generally been described in terms of fluid cleaning, and in terms of specific embodiments and implementations, the present invention is applicable to other methods, apparatuses, systems, and technologies. For example, the present invention has other uses in the automotive sector as well as many more in other markets including manufacturing, medical, and the food and beverage industry. Fluids that could benefit include transmission and brake fluids, cooling fluids, processing chemicals, cleaning agents, and cutting fluids. In addition, the examples provided herein are illustrative and not limiting. Those and other variations and modifications of the present invention are possible and contemplated, and it is intended that the foregoing specification and the following claims cover such modifications and variations.

1. A system, comprising:
an application including:
a housing;
an industrial fluid within the housing;
a fluid supply port and a fluid return port, wherein the fluid supply port and the fluid return port open into the housing;
a fluid cleaning system including:
a fluid supply port;
a fluid return port;
an evaporator including an air intake vent and an air exhaust vent;
a ventilation system connected to the evaporator and including:
a ventilation air path through the evaporator and connected to the intake vent and the exhaust vent in the evaporator;
an active airflow device located along the ventilation path;
a fluid line connecting the evaporator between the fluid supply port and the fluid return port;
a supply line connected between the supply port of the application and the supply port of the fluid cleaning system; and
a return line connected between the return port of the application and the return port of the fluid cleaning system.

2. The system of claim 1, wherein the ventilation system includes:
a dehumidifier located along the ventilation path;
an air filter located along the ventilation path; and
a heating element located along the ventilation path.

3. The system of claim 2, wherein the dehumidifier, air filter, and heating element are located in a portion of the ventilation path outside of the evaporator.

4. The system of claim 2, wherein the dehumidifier, air filter, and heating element are located in a portion of the ventilation path inside the evaporator.

5. The system of claim 1, wherein the ventilation system includes a first active air flow device located at the air intake vent and a second active airflow device located at the air exhaust vent.

6. The system of claim 1, further comprising:
a fluid flow controller;
a heating element in the evaporator;
a sensor connected to at least one of the fluid flow controller, the heating element, and the ventilations system;
a controller connected to an output of the sensor, wherein the controller includes:
a processor; and
a memory device including computer readable instructions which, when executed by the processor cause the processor to perform the steps of:
receiving data from the sensor;
comparing the data from the sensor to reference data stored in the memory device;
sending a control signal to the ventilation system based on comparing the data from the sensor to the reference data.

7. The system of claim 6, wherein:
the sensor is connected to at least one of the heating element, the fluid flow controller, and the ventilation system; and
sending a control signal to the ventilation system based on comparing the data from the sensor to the reference data includes:
sending a control signal to perform a operation when a condition is detected, wherein:
the operation is selected from a group comprising: reducing airflow through the evaporator, reducing temperature of air entering the evaporator, and increasing humidity of air entering the evaporator; and
the condition is selected from a group consisting of reduced fluid flow through the evaporator, reduced power to the heating element, reduced humidity in air entering the evaporator, increased temperature in air entering the evaporator.

8. The system of claim 7, further comprising:
sending a control signal to perform a operation when a condition is detected, wherein:
the operation is selected from a group comprising: increasing airflow through the evaporator, increasing temperature of air entering the evaporator, and decreasing humidity of air entering the evaporator; and
the condition is selected from a group consisting of increased fluid flow through the evaporator, increased power to the heating element, increased humidity in air entering the evaporator, increased temperature in air entering the evaporator.

9. The system of claim 6, wherein sending a control signal to the ventilation system based on comparing the data from the sensor to the reference data includes sending a control signal to reduce airflow through the evaporator when fluid flow through the evaporator decreases, and sending a control signal to increase airflow through the evaporator when fluid flow through the evaporator increases.

10. The system of claim 6, wherein:
the sensor is connected to the fluid flow controller; and
sending a control signal to the ventilation system based on comparing the data from the sensor to the reference data includes sending a control signal to reduce airflow through the evaporator when the fluid flow controller decreases fluid flow through the evaporator, and sending a control signal to increase airflow through the evaporator when the fluid flow controller increases fluid flow through the evaporator.

11. The system of claim 6, wherein:
the sensor is connected to the heating element; and
sending a control signal to the ventilation system based on comparing the data from the sensor to the reference data includes sending a control signal to reduce airflow through the evaporator when power to the heating element decreases, and sending a control signal to increase airflow through the evaporator when power to the heating element increases.

12. The system of claim 6, wherein:
the sensor is connected to the ventilation system; and
sending a control signal to the ventilation system based on comparing the data from the sensor to the reference data includes sending a control signal to reduce airflow through the evaporator when air entering the evaporator through the ventilation system becomes warmer, and sending a control signal to increase airflow through the evaporator when air entering the evaporator through the ventilation system becomes colder.

13. The system of claim 6, wherein:
the sensor is connected to the ventilation system; and
sending a control signal to the ventilation system based on comparing the data from the sensor to the reference data includes sending a control signal to reduce airflow through the evaporator when air entering the evaporator through the ventilation system becomes less humid, and sending a control signal to increase airflow through the evaporator when air entering the evaporator through the ventilation system becomes more humid.

14. A fluid cleaning system, comprising:
a fluid supply port;
a fluid return port;
an evaporator including an air intake vent and an air exhaust vent;
a ventilation system connected to the evaporator and including:
a ventilation air path through the evaporator and connected to the intake vent and the exhaust vent in the evaporator;
an active airflow device located along the ventilation path; and
a fluid line connecting the evaporator between the fluid supply port and the fluid return port.

15. A method of cleaning an industrial fluid, comprising:
receiving an industrial fluid in an evaporation chamber;
evaporating liquid contaminants from the industrial fluid in the evaporation chamber; and
actively ventilating the evaporation chamber.

16. The method of claim 15, wherein evaporating liquid contaminants includes heating the industrial fluid.

17. The method of claim 15, wherein evaporating liquid contaminants and actively ventilating the evaporation chamber include:
heating air from outside of the evaporation chamber to form heated air;
heating the industrial fluid with the heated air in the evaporation chamber;
changing liquid contaminants in the industrial fluid to gaseous contaminants in the evaporation chamber; and
actively moving the gaseous contaminants out of the evaporation chamber.

18. The method of claim 17, wherein heating air from outside of the evaporation chamber includes heating the air outside of the evaporation chamber and further comprising:
actively moving the heated air into the evaporation chamber before heating the industrial fluid with the heated air.

19. The method of claim 17, further comprising actively moving the air into the evaporation chamber before heating the air, wherein:
heating the air from outside of the evaporation chamber includes heating the air inside of the evaporation chamber after actively moving the air into the evaporation chamber.

20. The method of claim 17, further comprising filtering the air before heating the industrial fluid with the heated air.

21. The method of claim 17, further comprising reducing the humidity of the air before heating the industrial fluid with the heated air.

22. The method of claim 17, further comprising heating the industrial fluid prior to receiving the industrial fluid in the evaporation chamber.

23. An application, including:
a housing;
an industrial fluid within the housing; and
a fluid cleaning system, including:
a fluid supply port;
a fluid return port;
an evaporator including an air intake vent and an air exhaust vent;
a ventilation system connected to the evaporator and including:
a ventilation air path through the evaporator and connected to the intake vent and the exhaust vent in the evaporator;
an active airflow device located along the ventilation path; and
a fluid line connecting the evaporator between the fluid supply port and the fluid return port.
